(19) United States
(12) Patent Application Publication
(10) Pub. No.: US 2025/0310667 A1
(43) Pub. Date: Oct. 2, 2025

(54) REDUNDANT LASER SOURCE FOR OPTICAL SYSTEMS

(71) Applicant: MELLANOX TECHNOLOGIES, LTD., Yokneam (IL)

(72) Inventors: David ARBEL, Haifa (IL); Barak FREEDMAN, Binyamina (IL); Yannick Charles J. DE KONINCK, Hofstade (BE)

(73) Assignee: MELLANOX TECHNOLOGIES, LTD., Yokneam (IL)

(21) Appl. No.: 19/057,414

(22) Filed: Feb. 19, 2025

Related U.S. Application Data
(60) Provisional application No. 63/571,641, filed on Mar. 29, 2024.

(51) Int. Cl. H04Q 11/00; H04B 10/50

(52) U.S. Cl. CPC H04Q 11/0005; H04B 10/503; H04Q 11/0062; H04Q 2011/0039; H04Q 2011/0043; H04Q 2011/0081

(57) ABSTRACT

Systems, methods, and computer program products are described for a redundant external laser source in optical systems (e.g., CPO systems). An example system may include a plurality of ELS units, a RELS unit, an optical switch, and a plurality of optical couplers, and a control unit. The control circuit may be configured to detect an operational failure of a first ELS unit. In response to detecting such a failure, the control circuit may configure the RELS unit to replace the first ELS unit and, using the optical switch, substitute the first ELS unit with the RELS unit. Such a configuration ensures continuous system performance by dynamically replacing failing ELS units with redundant ELS units, thereby reducing downtime and enhancing the reliability of the optical communication system.

### CROSS-REFERENCE TO RELATED APPLICATIONS

This application claims priority to U.S. Application No. 63/571,641, filed Mar. 29, 2024, the contents of which is hereby incorporated by reference in its entirety.

### TECHNOLOGICAL FIELD

Example embodiments of the present disclosure relate to a redundant laser source for optical systems.

### BACKGROUND

Optical systems are fundamental to modern telecommunications and data processing, offering high-speed communication and efficient data handling through light transmission. Co-Packaged Optics (CPO) represents an advanced form of these systems by integrating high-speed optical interconnects with key processing units, such as ASICs or GPUs, on a shared substrate. While CPO systems promise enhanced performance, they are hampered by the reliability concerns of laser components, particularly External-Laser Source (ELS) units.

Applicant has identified a number of deficiencies and problems associated with failing ELS units. Many of these identified problems have been solved by developing solutions that are included in embodiments of the present disclosure, many examples of which are described in detail herein.

### GENERAL DESCRIPTION

Systems, methods, and computer program products are therefore provided for a redundant external laser source for CPO systems. By introducing a redundancy framework, embodiments of the disclosure ensure continuous operation of CPO systems despite the failure of any laser component, thereby improving system reliability and maintenance flexibility without significantly increasing costs or complexity.

In one aspect, a network switch system is presented. The network switch system comprising: a plurality of external laser source (ELS) units; a redundant external laser source (RELS) unit; an optical switch operatively coupled to the RELS unit; and a control circuit operatively coupled to the plurality of ELS units, the RELS unit, and the optical switch, wherein the control circuit is configured to: detect an operational failure of a first ELS unit; and in response to detecting the operational failure of the first ELS unit: configure the RELS unit to replace the first ELS unit; and substitute, using the optical switch, the first ELS unit with the RELS unit.

In some embodiments, in substituting the first ELS unit with the RELS unit, the control circuit is further configured to: disengage, using an optical coupler associated with the first ELS unit, the first ELS unit; and engage the RELS unit in place of the first ELS unit.

In some embodiments, the optical coupler comprises passive optical couplers, wherein the passive optical couplers comprise optical combiners.

In some embodiments, the optical coupler comprises active optical couplers, wherein the active optical couplers comprise optical switches.

In some embodiments, the control circuit is further configured to: deactivate the first ELS unit prior to substituting the first ELS unit with the RELS unit.

In some embodiments, a transition time associated with the substitution of the first ELS unit with the RELS unit is in a range of approximately 1-10 milliseconds.

In some embodiments, the control circuit is configured to continuously monitor an operational status of each ELS unit.

In some embodiments, the control circuit is further configured to: capture performance characteristics of each ELS unit in real-time; detect, using a machine learning model, that the first ELS unit is likely to operationally fail based on the captured performance characteristics of each ELS unit; and substitute, using the optical switch, the first ELS unit with the RELS unit prior to the operational failure of the first ELS unit.

In some embodiments, the performance characteristics comprise at least one of optical characteristics, electrical characteristics, physical characteristics, or thermal characteristics.

In some embodiments, the control circuit is further configured to: train the machine learning model using known performance characteristics and known operational status associated with each ELS unit, wherein detecting that the first ELS unit is likely to operationally fail comprises using the trained machine learning model.

In some embodiments, the RELS unit is maintained in an off state or stand-by state when the plurality of ELS units is operational.

In some embodiments, in configuring the RELS unit to replace the first ELS unit, the control circuit is further configured to: configure parameters of the RELS unit to match parameters of the first ELS unit prior to substituting the first ELS unit with the RELS unit.

In some embodiments, the control circuit is further configured to: determine an addition of a new ELS unit to replace the first ELS unit; configure parameters of the new ELS unit; and substitute the RELS unit with the new ELS unit, thereby replacing the first ELS unit.

In some embodiments, the control circuit is further configured to: deactivate the RELS unit in response to substituting the RELS unit with the new ELS unit.

In some embodiments, the system is a co-packaged optical (CPO) system.

In yet another aspect, a method is presented. The method comprising: detecting an operational failure of a first external laser source (ELS) unit in a plurality of ELS units; and in response to detecting the operational failure of the first ELS unit: configuring a redundant external laser source (RELS) unit to replace the first ELS unit; and substituting, using an optical switch, the first ELS unit with the RELS unit.

In yet another aspect, a computer program product is presented. The computer program product comprising a non-transitory computer-readable medium comprising code that, when executed by a processor, causes the processor to: detect an operational failure of a first external laser source (ELS) unit in a plurality of ELS units; and in response to detecting the operational failure of the first ELS unit: configure a redundant external laser source (RELS) unit to replace the first ELS unit; and substitute, using an optical switch, the first ELS unit with the RELS unit.

In yet another aspect, a network switch system is presented. The network switch system comprising: a plurality of external laser source (ELS) units; a redundant external laser source (RELS) unit; an optical device, wherein the optical device comprises a plurality of optical splitters, wherein the optical device is operatively coupled to the RELS unit; and a control circuit operatively coupled to the plurality of ELS units, the RELS unit, and the optical device, wherein the control circuit is configured to: detect an operational failure of a first ELS unit; and in response to detecting the operational failure of the first ELS unit: configure the RELS unit to replace the first ELS unit; and substitute, using an optical splitter corresponding to the first ELS unit, the first ELS unit with the RELS unit.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1B illustrate an example system for providing operational resilience for ELS units, in accordance with an embodiment of the present disclosure;

FIG. 1C illustrates a schematic block diagram of the system having an optical coupler configuration, in accordance with an embodiment of the present disclosure;

FIG. 1D illustrates a schematic block diagram of the system having an example optical splitter configuration, in accordance with an embodiment of the present disclosure;

FIG. 1E illustrates an optical device as an example CPO device, in accordance with an embodiment of the present disclosure;

FIG. 1F illustrates a schematic block diagram of example device circuitry, in accordance with an embodiment of the present disclosure;

FIG. 2 illustrates an exemplary machine learning architecture in accordance with an embodiment of the disclosure;

FIG. 3 illustrates an example method for providing operational resilience for a failed ELS unit, in accordance with an embodiment of the disclosure;

FIG. 4 illustrates an example method for providing operational resilience for a failing ELS unit, in accordance with an embodiment of the disclosure;

FIG. 5 illustrates an example implementation for providing operational resilience, in accordance with an embodiment of the disclosure;

FIG. 6 illustrates an example datacenter, in accordance with an embodiment of the disclosure;

FIG. 7 illustrates a fat tree topology for a datacenter, in accordance with embodiments of the disclosure.

### DETAILED DESCRIPTION

### Overview

Optical systems use light to transmit data, enabling high-speed communication and efficient data processing. Optical systems are integral to modern telecommunications, datacenters, and computing networks, offering advantages such as increased bandwidth, lower latency, and reduced electromagnetic interference compared to traditional electronic systems. Co-Packaged Optics (CPO) is a specific type of optical system that exemplifies these benefits by integrating high-speed optical interconnect components with key processing units, such as Switch ASICs or GPUs, on a shared substrate. Such integration allows for improved performance and efficiency, making CPO systems a significant advancement in the field of optical communications.

Some CPO systems may operate using multiple laser sources housed in External-Laser Source (ELS) units. These ELS units provide the light source for SiPh optical transmitters, which encode data onto optical pulses for transmission. A common issue with CPO systems is the reliability of laser components (e.g., ELS units) over time. Degradation in laser performance can reduce system throughput or bandwidth, cause downtime, or lead to system failure. Replacing failed ELS units presents challenges in maintenance and operational complexity, with a focus on minimizing system downtime. Laser reliability concerns hinder the broader commercial adoption of CPO systems, delaying the anticipated benefits, as the risk of system failure or reduced performance introduces risks that stakeholders are hesitant to accept without mitigation strategies.

Conventional solutions to these challenges have included both component and system-level approaches. One method involves adding more laser components, potentially doubling the number to create redundancy or adding redundancy in the switch system level, which increases cost and reduces efficiency of resource utilization. Another strategy increases the system's overall capacity to compensate for any loss of functionality due to component failure. These solutions aim to enhance reliability but also result in increased costs, larger system footprints, added complexity, and reduced efficiency.

Embodiments of the disclosure address the reliability issues of laser components in optical systems, such as CPO systems, by introducing a laser redundancy framework. The laser redundancy framework ensures continuous system performance despite the failure of any laser component, allowing for maintenance and replacement of failed or failing ELS units at a more convenient time without immediate urgency. An example system may include a Redundant ELS

(RELS) unit with multiple lasers serving as a backup to the ELS units, a low loss optical switch facilitating dynamic rerouting of optical paths in response to ELS unit failures, an optical coupler for each ELS unit configured to merge optical signals from two inputs into a single output, and a control circuit with software and hardware components integrated into the system to control the low loss optical switch and RELS unit operation. Upon detecting an operational failure in an ELS unit, the control circuit may activate the RELS unit, using the low loss optical switch and optical couplers to replace the failed ELS unit with the RELS unit.

The RELS unit may be identical to the ELS units integrated within the optical module and may be configured to serve as a backup to a ground of ELS units. The ELS units may maintain their nominal size and cost, with the cost of the RELS unit distributed across the system. One RELS unit may be configured to serve redundancy for m ELS modules in the system (m can be for example 8, 16 or 32 lasers). For example, the RELS unit may represent approximately 5% of the total system cost (e.g., 1 RELS unit for 16 ELS units). The example system may employ both active optical couplers, such as optical switches, and passive optical couplers, such as optical combiners, to modify the routing of the optical path. Specific parameters of the RELS unit may be configured to match those of the failed ELS unit. Machine learning techniques may be utilized to predict impending failures, enabling proactive activation of the RELS unit. The control unit may continuously monitor the operational status of each ELS unit by assessing optical, electrical, and physical/thermal characteristics. The low loss optical switch may be capable of instantly transitioning between the failed or failing ELS unit and the RELS unit. The switching process may be completed within a short timeframe of 1-10 milliseconds, preventing data loss or link interruption, allowing for the system to recover and keep data path operational keep data path operational. Maintenance operations may include replacing the failed or failing ELS unit with a new ELS unit, configuring the new ELS unit with updated parameters, testing, and re-engaging it into the optical system. Once the new ELS unit is operational, the RELS unit is deactivated and returned to standby mode. In this way, the example system may significantly improve laser reliability over an extended period. While conventional solutions may temporarily deactivate affected lanes while awaiting the swift replacement of a faulty ELS unit to reduce downtime, the RELS-based switching solution offers greater maintenance flexibility, allowing the faulty ELS module to be replaced at a more convenient time.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example System

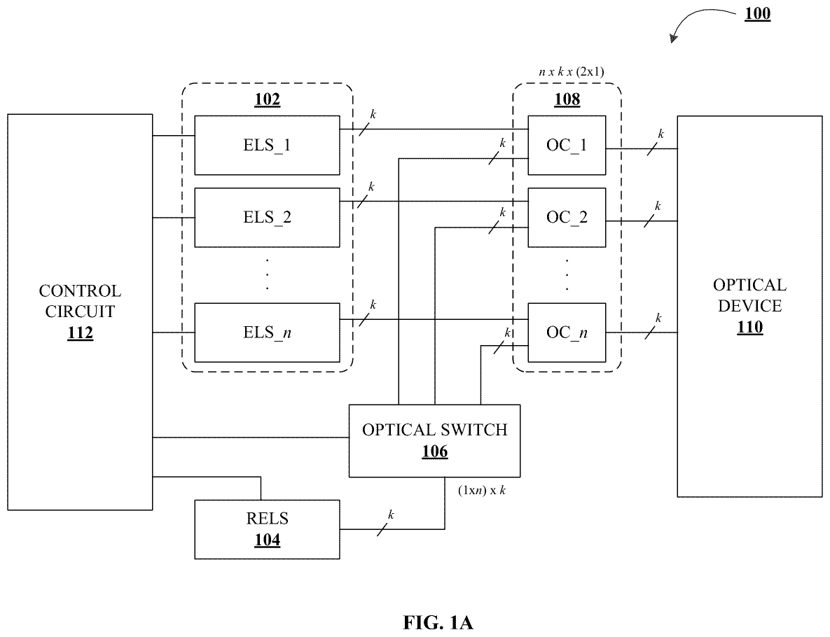

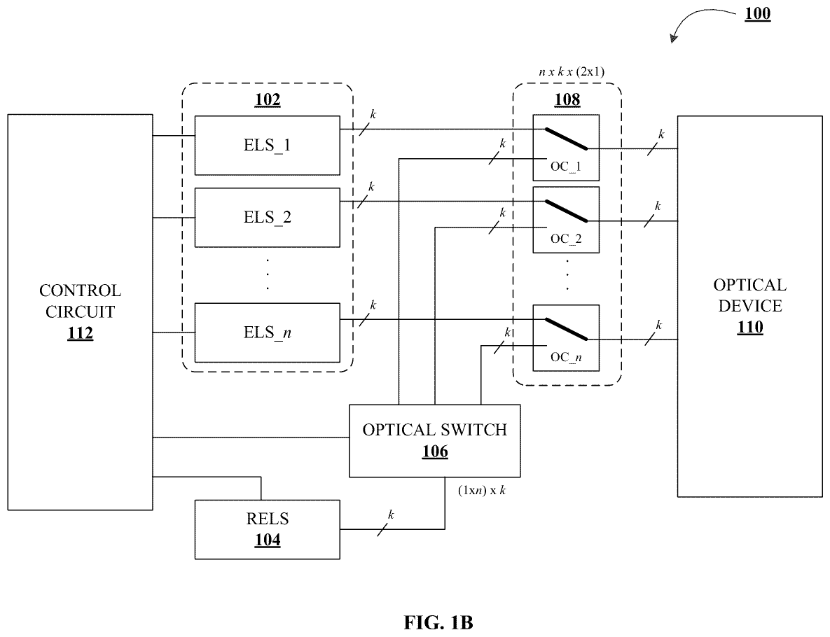

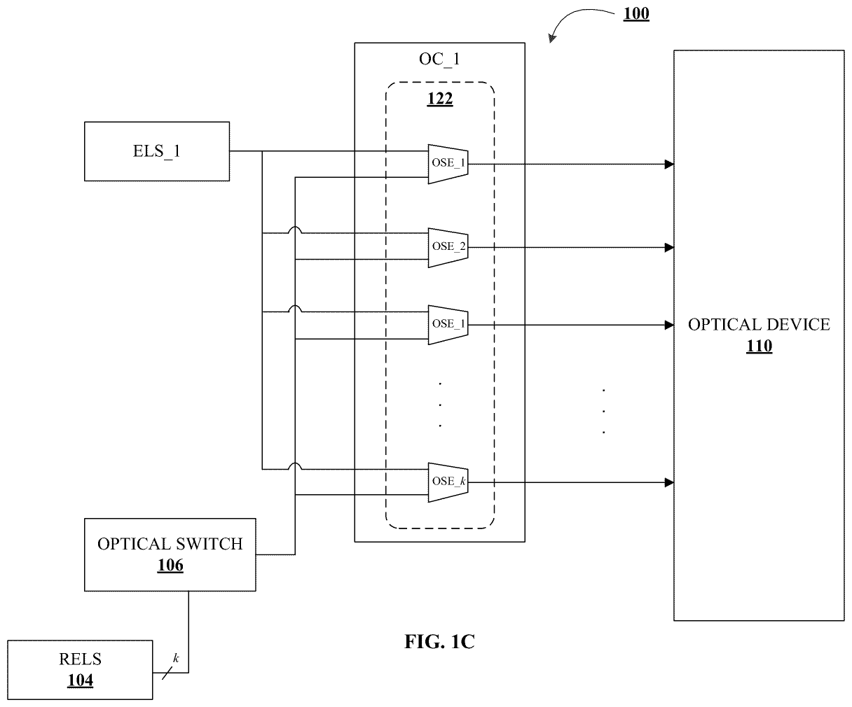

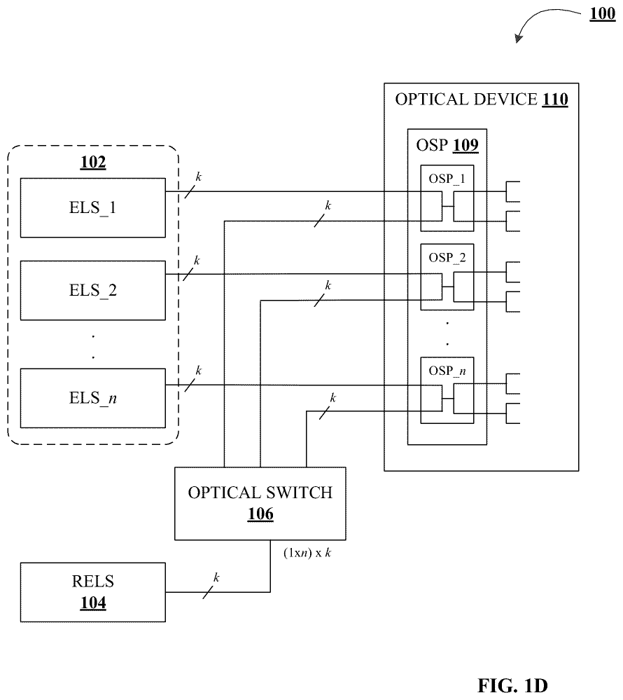

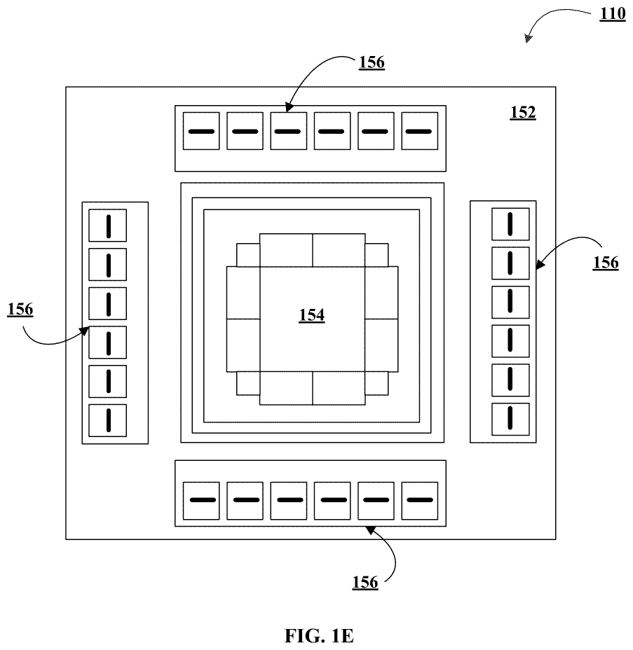

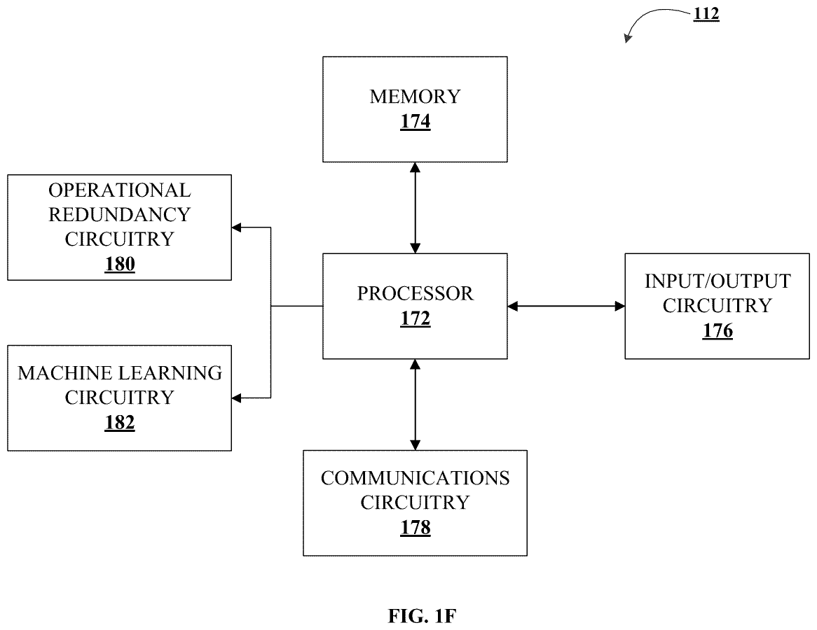

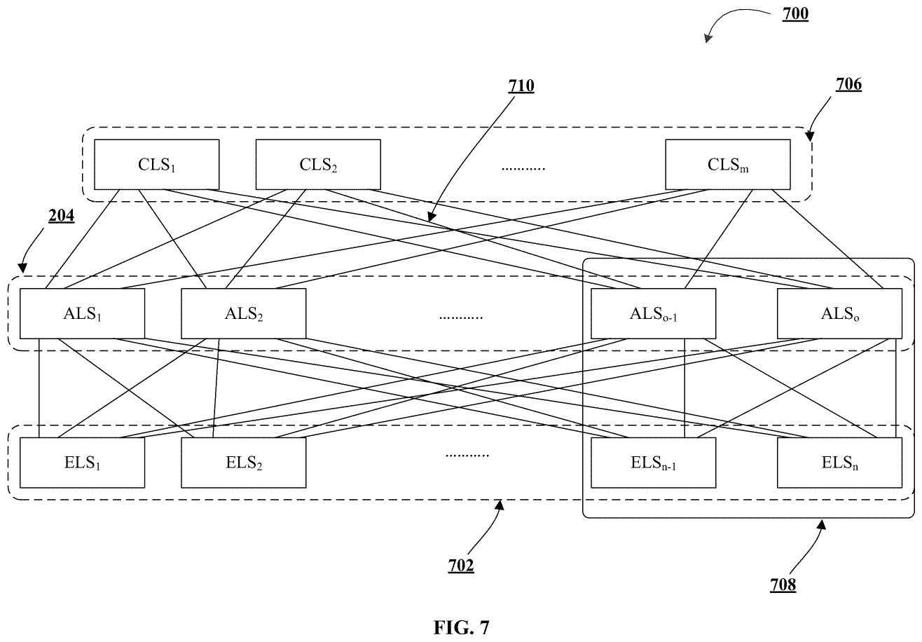

FIGS. 1A-1B illustrate an example system 100 for providing operational resilience for ELS units, in accordance with an embodiment of the present disclosure. The system 100 of the present disclosure may incorporate any of the aforementioned functionalities, including those of electrical switches, optical switches, hybrid electro-optical switches, or any combination thereof, as described in further detail herein. The system 100 may be configured to be versatile and adaptable, enabling it to replace any of the switches (or PODs of switches) in the network topology, including those in the edge layer 702, aggregation layer 704, or core layer 706, as shown in FIG. 7.

As shown in FIGS. 1A-1B, the system 100 (e.g., CPO system) may a plurality of ELS units 102 (e.g., ELS_1, ELS_2, . . . , ELS_n), an RELS unit 104, an optical switch 106, a plurality of optical couplers 108 (e.g., OC_1, OC_2, . . . , OC_n), an optical device 110, and a control circuit 112.

Each ELS unit (e.g., ELS_i) in the plurality of ELS units 102 may serve as a discrete unit, providing the necessary optical signals for the operation of the optical device 110. Each ELS unit may house multiple lasers therewithin, each of which may be designed to support multiple operational lanes. For instance, an ELS unit may incorporate eight (8) lasers, with each laser supporting four (4) lanes. In an example embodiment, an ELS unit may include multiple laser diodes, each capable of emitting high-intensity coherent light upon the flow of electrical current; a thermal management system, which may incorporate heat sinks, thermoelectric coolers, or fluidic mechanisms to ensure that the lasers operate within their optimal temperature range; an optical modulator capable of modulating phase, amplitude, polarization, and/or the like of the coherent light; WDM and/or Polarization Multiplexing components for allowing simultaneous transmission of multiple signal channels at different wavelengths and/or polarizations through a single optical fiber; driver circuitry configured to provide precise control over the electrical current supplied to each laser diode for stable operation and modulation fidelity; and feedback control mechanisms to monitor each laser's output and dynamically adjust parameters such as power levels, wavelength stability, and modulation depth to maintain optimal performance. Furthermore, each laser within a particular ELS unit may be configurable, allowing for the adjustment of parameters including output power, wavelength, modulation scheme, bias current, and temperature set point. It should be understood that the aforementioned embodiment of the ELS serves as an exemplary configuration, illustrating the principles and potential of such a system in a co-packaged optical arrangement. It should be understood, however, that this depiction is not limiting. Various alterations, modifications, and improvements can be envisaged within the scope of the disclosure, as dictated by technological advancements and specific application requirements. Future embodiments may include variations in the number of lasers, the configuration of optical components, the integration of advanced modulation techniques, enhancements in thermal management and power efficiency, and/or the like.

The RELS unit 104 may be configured to have same or similar structural and functional characteristics of an ELS unit described herein. For example, the RELS unit 114 may have same or similar physical structure and design as that of the ELS units; the RELS unit 114 may be configured to include similar types of optical components as the ELS units, such as lasers (e.g., DFB lasers, VCELs, and/or the like), isolators, splitters, and/or the like; the RELS unit 114 may replicate functional capabilities of the ELS units including the ability to emit light at specific wavelengths as required by the system; and/or the RELS unit 114 may have similar dynamic range and output power levels to maintain consistent signal quality and system performance. As such, the RELS unit 104 may serve as a discrete unit, capable of providing the necessary optical signals for the operation of the optical device 110.

By incorporating an RELS unit 104 with similar structural and functional characteristics analogous to that of an ELS unit, the optical device 110 may be provided a fail-safe mechanism that ensures continuous operation in the event of a failure, degradation in performance, or replacement of a particular ELS unit in the plurality of ELS units 102. Alternatively or additionally, the RELS unit 104 may exhibit structural and functional characteristics distinct from the configurations typically associated with an ELS unit described herein. The RELS unit 104, however, may be configured, reconfigured or adapted to replace any ELS unit in an event of a failure, degradation in performance, or replacement. In example embodiments, the RELS unit 104 may be configured to provide backup or redundancy for multiple ELS units simultaneously. For instance, the RELS unit 104 may incorporate sixteen (16) lasers capable of providing redundancy for two (2) ELS units, each incorporating eight (8) lasers therein. In such instances, since one RELS unit 104 may serve as backup to multiple ELS units, the cost of adding this redundancy may be distributed across the ELS units. Consequently, the incremental cost of incorporating the RELS unit 104, when amortized over the n ELS units it supports, represents a minor percentage increase—less than 51—in the total cost of the ELS units in the system. Furthermore, the implementation of the RELS unit 104 may introduce an increase in loss (around approximately 1.5 dB) along the switching path. This loss can be compensated for by increasing the optical power of the lasers associated with the RELS unit 104. However, this adjustment may only be necessary during the operation of the RELS unit 104, until the faulty ELS unit is replaced by a new ELS unit and the system returns to its standard operational configuration. At this time, the RELS unit 104 that was used to provide backup or redundancy for the compromised ELS unit may be deactivated.

The optical switch 106 may be used to provide dynamic routing capabilities. In particular, the optical switch 106 may be configured to facilitate transition from any ELS unit (e.g., ELS_i) to the RELS unit 104 in the event of a failure, degradation in performance, or replacement of the ELS_i. The optical switch may be a 1×n configuration, featuring low insertion loss and a switching time that can range from microseconds to milliseconds or even seconds, depending on the specific requirements of the system. A compact switch module can integrate k such switches, and k optical fiber 2-to-1 combiners can be utilized, as described in detail in FIG. 1C.

Optical switches (e.g., optical switch 106) are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies, e.g., fat trees, Slim Fly, and Dragonfly+). In addition, inventive concepts propose to place such hybrid switching systems “in the middle” of the network (e.g., replacing the edge/top of rack (TOR) layer and aggregation layer).

Optical switch 106 may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. The optical switch 106 may include one or more devices for amplifying light in order to compensate for propagation and scattering losses introduced by the optical switch 106. In at least one example embodiment, signals input and output to an ASIC are optical, meaning that the optical switch 106 connected to an electrical switch routes optical signals received from the electrical switch without using hardware and/or software that converts an electrical signal into an optical signal for routing within the optical switch. However, example embodiments are not limited thereto, and the optical switch 106 may include electrical to optical to electrical conversion hardware and/or software if desired (e.g., if the input signal and/or output signal is an electrical signal).

In a specific embodiment comprising 16 ELS units, where each ELS unit is equipped with eight (8) lasers, the system may be configured to incorporate eight (8) optical switches. Each optical switch may operate in a 1×16 configuration, facilitating the redirection of optical signals from any of the 16 ELS units to the appropriate output channels.

As shown in FIGS. 1A-1B, each ELS unit may be associated with a dedicated optical coupler 108 configured to route optical signals from a corresponding ELS unit to the optical device 110. Optical couplers may refer to devices used to combine or split optical signals in a network, facilitating the transmission of light from one point to another. As such, optical couplers may be used to direct optical signals to their intended destinations within the system. In an instance in which an ELS unit (e.g., ELS_2) is determined to be failing or having failed, the optical coupler, OC_2, corresponding to ELS_2 may be configured to disengage connection with ELS_2, and instead, route optical power to the optical device 110 from the RELS unit 104 to maintain uninterrupted signal transmission within the system.

As shown in FIGS. 1A-1B, the optical couplers may be configured in an n×(1×k) arrangement, where there are n optical couplers, each corresponding to a distinct ELS unit (e.g., ELS_2). Each optical coupler may be capable of directing optical signals from k optical fibers, allowing for flexible routing of light within the network, as described in more detail in FIG. 1C. In an instance in which an ELS unit (e.g., ELS_2) is determined to be failing or has failed, the optical coupler, OC_2, corresponding to ELS_2, may be configured to disengage its connection with ELS_2 and instead route optical power to the optical device 110 from the RELS unit 104 to maintain uninterrupted signal transmission within the system. Each optical coupler may include k optical switching elements, with each element responsible for rerouting the optical signal from its corresponding optical fiber. When this occurs, the optical signals from all k optical fibers can be simultaneously rerouted.

The optical couplers 108 may be passive optical couplers or active optical couplers. Passive optical couplers, such as optical combiners, merge signals without the need for external power or control mechanisms. Passive couplers are typically lower in cost but have higher signal loss, often around 1FB on each channel, which places greater demands on the ELS units, requiring the ELS units to operate at higher power levels (about double the optical power than a standard ELS unit) or with greater precision to ensure signal integrity. On the other hand, active optical couplers, including optical switches (as shown in FIG. 1B), manage signal routing dynamically, often with the aid of external power and control systems. While active couplers are more expensive and larger in size, they offer lower signal loss (less than 5%), reducing the operational demands on the ELS units. Because active couplers compensate for signal losses and optimize the routing of optical paths, only the RELS unit needs to operate with higher power lasers-approximately 10% higher power-rather than requiring all ELS units to use high-power lasers, as would be necessary with passive couplers. This configuration places less strain on the ELS units, allowing them to operate more efficiently and extend their lifespan. The lifetime of the RELS lasers may be prolonged by their short operation time, and the RELS unit can provide redundancy at the system level for the whole lifetime of each ELS unit, thus removing the laser reliability concern and allowing CPO system easier deployment and operation. The choice between passive and active optical couplers may depend on the specific requirements of the optical system. Passive couplers may be suitable for applications where cost and space efficiency are important considerations, and where the ELS units can sustain the higher demands placed upon them. In contrast, active couplers may be better suited for scenarios where reliability and flexibility are important considerations, offering greater system stability and reduced maintenance needs by minimizing the operational burden on the ELS units. In accordance with the present disclosure, it is to be understood that the plurality of optical couplers described herein may comprise any configuration of passive optical couplers, active optical couplers, or a combination thereof depending on the specific requirements of the optical communication system. Such variations and modifications are within the scope of the present disclosure. Additionally, any particular embodiments, configurations, or combinations disclosed herein are illustrative and not intended to limit the scope of the disclosure, which should be interpreted to cover all equivalent modifications and variations that fall within the spirit of the disclosure.

In specific embodiments, the optical switch 106 and the optical couplers 108 may be integrated into a single modular unit to streamline the system architecture, reduce physical space requirements, and enhance operational efficiency. Such an integrated unit may house both the dynamic routing functionality of the optical switch and the signal splitting or combining capabilities of the optical couplers. The integrated unit may also include shared control electronics to manage the routing and coupling processes, enabling seamless communication between the ELS units, the RELS unit, and the optical device.

The optical device 110 may refer to a wide range of optical and/or electrical equipment designed to generate, manipulate, or detect light. In a particular embodiment, the optical device 110 may be a CPO device, such as a Silicon Photonics (SiPh) optical transmitter. Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

CPO devices may be advanced optical communication solutions where optical components are integrated closely with electronic processing units, such as Switch ASICs or GPUs, on a shared substrate. Such integration reduces latency, increases bandwidth, and improves energy efficiency by minimizing the physical distance between the optical and electronic components. In an example case of a SiPh CPO device, the laser sources housed within each ELS unit may serve as the primary light source. These laser sources generate light that the SiPh optical transmitter may encode onto optical pulses, enabling high-speed data transmission through optical fibers. The close integration of optical and electronic components in SiPh CPO devices provides significant performance advantages, making them highly suitable for applications in datacenters, high-performance computing, and telecommunications networks. Beyond SiPh CPO devices, other types of CPO devices may be utilized depending on the specific application requirements. These may include devices employing different materials or technologies for optical transmission, such as Indium Phosphide (InP)-based CPO devices or hybrid CPO devices that incorporate various photonic integration methods. Each type of CPO device may be configured to maximize the benefits of co-packaging optical and electronic components, addressing the growing demands for bandwidth, speed, and energy efficiency in modern communication infrastructures. The present disclosure contemplates all such variations and modifications of CPO devices, as they fall within the scope of the disclosed embodiments.

The control circuit 112 may be configured to implement a broad spectrum of operational requirements within the system 100. To this end, the control circuit 112 may include a diverse array of components, including but not limited to, programmable logic controllers (PLCs), microcontrollers, digital signal processors (DSPs), custom integrated circuits (ICs), and/or the like, as described in detail in FIG. 1F. In addition to its core functionality, the control circuit 112 may also incorporate diagnostic and prognostic modules, leveraging advanced algorithms and machine learning techniques to monitor functional characteristics of the ELS units, predict/detect potential failures in ELS units and/or automate maintenance schedules for replacement and repair. As such, the control circuit 112 may include a plurality of environmental sensors, power management units, wavelength meters, beam profilers, thermal cameras, self-test mechanisms, and/or the like. The control circuit 112 may be implemented within a diverse range of hardware platforms varying from dedicated embedded systems and industrial computers to sophisticated server arrays and cloud-based computing resources. Each platform choice may depend on the specific requirements of the system 100, including processing power, scalability, and environmental considerations.

In an embodiment of the present disclosure, the system 100 may be configured to support an optical switch system comprising m channels, where m=(n×k×l). The parameter n may represent the number of ELS units 102 integrated into the system 100, k may denotes the number of lasers within each ELS unit, and/may refer to the number of optical channels generated by each laser through internal splitting within the PIC of the optical device 110. In a specific example, n may be set to sixteen (16) ELS units, each ELS unit incorporating eight (8) lasers (k=8), and each laser splitting into four (4) channels (l=4), resulting in a total of 512 channels (m=512). This framework provides scalability, allowing future systems to increase the channel count, such as m=1024, by modifying n, k, or l in accordance with system requirements. For example, the system may integrate sixteen (16) ELS units, each housing eight (8) lasers that are split into eight (8) channels per laser, yielding 1024 total channels. Alternatively, the architecture may be restructured to consolidate all (n×k) lasers into a single module, tray, or board, rather than discrete ELS units, thus simplifying interconnectivity and enhancing thermal management. In an embodiment where n=1 and k=128, all 128 lasers may be integrated into a unified assembly, facilitating a streamlined and compact system design. Moreover, redundancy can be incorporated into the system 100 by reallocating the distribution of lasers among multiple switches or modules. These design principles permit the deployment of high-density, scalable, and resilient optical switching systems suitable for datacenters, telecommunications networks, and other applications requiring robust optical interconnectivity.

It is to be understood that the structure of the system 100 and its components, connections and relationships, and their functions, are meant to be exemplary only, and are not meant to limit implementations of the disclosures described and/or claimed in this document. In one example, the system 100 may include more, fewer, or different components. In another example, some or all of the portions of the system 100 may be combined into a single portion or all of the portions of the system 100 may be separated into two or more distinct portions.

### Example Optical Coupler Configuration

FIG. 1C illustrates a schematic block diagram of the system 100 having an optical coupler configuration, in accordance with an embodiment of the present disclosure. As shown in FIG. 1C, the optical coupler, OC_1, may include a set of optical switching elements (OSEs) 122 OSE_1, OSE_2, . . . , OSE_k. Each OSE within the optical coupler may be configured for directing optical signals from a corresponding optical fiber connected to the ELS_1 unit or the RELS unit 104 via the optical switch 106.

In this configuration, each OSE may be operatively coupled to an optical fiber input and is capable of selectively routing optical signals from the ELS_1 or from the RELS unit 104 through the optical switch 106 to the optical device 110. The optical switch 106 may serve as a control mechanism that can redirect the optical path based on the operational status of the ELS_1 unit. For example, if ELS_1 is determined to be failing or has failed, the optical switch 106 may transmit a control signal to the optical coupler OC_1 to disengage the optical path from ELS_1 and instead engage the RELS unit 104. This switching action may be achieved simultaneously across all k optical switching elements (OSE_1 to OSE_k), ensuring that all optical signals from the k optical fibers are rerouted to maintain uninterrupted signal transmission to the optical device 110.

It is to be understood that FIG. 1C and the associated description thereof are provided merely as illustrative embodiments of the present disclosure. These embodiments are not intended to be exhaustive or to limit the disclosure to the precise form or configuration disclosed. Those skilled in the art will recognize that various modifications, substitutions, and alterations may be made without departing from the scope and spirit of the disclosure as defined by the appended claims. The use of specific terms herein is for illustrative purposes only and is not intended to limit the scope of the disclosure. All such variations, alternatives, and modifications are intended to be included within the scope of the present disclosure.

### Example Optical Splitter Configuration

FIG. 1D illustrates a schematic block diagram of the system 100 having an example optical splitter configuration, in accordance with an embodiment of the present disclosure. As shown in FIG. 1D, the optical device 110 may include a plurality of optical splitters 109 (OSP_1, OSP_2, . . . , OSP_n) (e.g., 2×2 optical splitters) integrated therewithin, eliminating the need for external components such as optical couplers (e.g., optical coupler 108). By directly implementing optical splitters in the optical device 110 silicon, the optical splitter configuration may achieve greater integration and efficiency, reducing external dependencies and simplifying the overall system architecture.

The lasers within this embodiment may be configured to split their outputs into multiple waveguide channels (e.g., 2, 4, or 8 channels) as part of the optical device's 110 internal configuration. This allows the plurality of optical splitters 109 to be readily implemented without additional size, cost, or power consumption. The optical splitting process may introduce a loss of 0.2-0.1 dB, but this loss is inherently accounted for in the design of the optical device 110 and does not impose additional penalties compared to external components. Consequently, this embodiment provides a cost-effective and compact solution for optical signal distribution within the system, optimizing energy efficiency and minimizing physical footprint.

While this approach offers significant advantages, in some embodiments, it may also introduce certain trade-offs. Specifically, the elimination of external optical couplers or switches may require doubling the number of laser inputs to the optical device 110. Additionally, the number of polarization-maintaining (PM) fibers required for the system may increase to accommodate the additional laser channels. For example, in a 16-channel system, the total number of fibers may increase from 16 to 40, comprising 16 transmission fibers, 16 reception fibers, and an increase from 4 to 8 laser input fibers. This increase in fiber count and connector size may necessitate modifications to the optical connector design but remains a manageable trade-off given the benefits of the integration.

By integrating optical splitters 109 directly into the optical device 110, embodiments of the disclosure remove the need for external power-consuming components and reduces overall system complexity. Furthermore, this configuration is particularly suitable for high-density optical systems where space and energy efficiency are key considerations.

In this configuration, if an ELS unit (e.g., ELS_2) in the system 100 experiences degradation or failure, the integrated optical splitters 109 within the optical device 110 enable the system 100 to reroute signals from the RELS unit 104 through alternative waveguide paths. By leveraging the splitting functionality implemented directly within the PIC (optical device 110), the system 100 can dynamically redistribute the optical signals. This rerouting ensures that signal transmission remains uninterrupted and minimizes the impact of the failure on overall system performance. The use of integrated splitters (e.g., OSP 109) may eliminate reliance on external components for such rerouting, thereby simplifying the recovery process and enhancing the resilience of the optical communication system.

It is to be understood that FIG. 1D and the associated description thereof are provided merely as illustrative embodiments of the present disclosure. These embodiments are not intended to be exhaustive or to limit the disclosure to the precise form or configuration disclosed. Those skilled in the art will recognize that various modifications, substitutions, and alterations may be made without departing from the scope and spirit of the disclosure as defined by the appended claims. The use of specific terms herein is for illustrative purposes only and is not intended to limit the scope of the disclosure. All such variations, alternatives, and modifications are intended to be included within the scope of the present disclosure.

### Optical Device as an Example CPO Device

FIG. 1E illustrates an optical device 110 as an example CPO device, in accordance with an embodiment of the present disclosure. As shown in FIG. 1F, the example CPO device may include a substrate 152, an integrated circuit (IC) 154, and optical modules 156.

The substrate 152 may provide the foundational platform for the integration of both optical and electronic components in the CPO device 110. The substrate 152 may be configured to accommodate high-density interconnects and facilitate efficient thermal management for both the IC 154 and the optical modules 156. The substrate 152 may be fabricated from a high-performance material such as silicon or a silicon-based composite, providing a stable base for the precise alignment and coupling of optical fibers and electronic interconnections. The substrate 152 may also include embedded conductive pathways to enable high-speed data communication between the IC 154 and the optical modules 156.

The IC 154 may be centrally positioned on the substrate 152 and serve as the primary processing unit within the CPO device. The IC 154 may be a high-performance switch die, ASIC, or other network processing unit responsible for managing data traffic and controlling the overall operation of the CPO device 110. The IC 154 may be electrically connected to the substrate and optically aligned with the surrounding optical modules 156 to facilitate seamless integration of electronic and optical functions. The IC 154 may be configured to handle high-speed signal processing tasks, such as packet forwarding, routing, and signal modulation, ensuring low-latency communication between different network segments. The proximity of the IC 154 to the optical modules 156 on the shared substrate 152 allows for reduced power consumption and increased data throughput by minimizing the distance over which high-speed signals must travel.

The optical modules 156 may be positioned around the periphery of the IC 154 on the substrate 152. Each optical module 156 may be responsible for the conversion of electrical signals generated by the IC 154 into optical signals for transmission over optical fibers and vice versa. These optical modules 156 may contain various optical components, such as lasers, modulators, photodetectors, and photonic integrated circuits (PICs), which enable the optical transmission and reception of data. The optical modules 156 may be placed to ensure optimal alignment with the IC 154 and to maintain efficient thermal dissipation. Additionally, the optical modules 156 may be configured to support various data rates and communication protocols, providing flexibility and scalability for different network applications. The integration of the optical modules 156 around the IC 154 may allow for high-density optical I/O, supporting the increasing bandwidth demands of modern datacenters and high-performance computing environments.

It should be understood that FIG. 1F and the accompanying description are provided merely as illustrative embodiments of the present disclosure. These embodiments are not intended to limit the disclosure to the precise arrangements, configurations, or components disclosed. Various modifications, substitutions, and alterations may be made by those skilled in the art without departing from the spirit and scope of the disclosure. The descriptions herein are intended for illustrative purposes only, and all such variations, alternatives, and modifications are considered to fall within the scope of the present disclosure.

### Example Control Unit Circuitry

FIG. 1F illustrates a schematic block diagram of example control unit circuitry, in accordance with an embodiment of the present disclosure. As shown in FIG. 1F, the control circuit 112 may include a processor 172, a memory 174, input/output circuitry 176, communications circuitry 178, operational redundancy circuitry 180, and a machine learning circuitry 182.

Although the term “circuitry” as used herein with respect to components 172-182 is described in some cases using functional language, it should be understood that the particular implementations necessarily include the use of particular hardware configured to perform the functions associated with the respective circuitry as described herein. It should also be understood that certain of these components 172-182 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the control circuit 112 may be housed together, while other components are housed separately (e.g., a controller in communication with the control circuit 112). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the control circuit 112 may provide or supplement the functionality of particular circuitry. For example, the processor 172 may provide processing functionality, the memory 174 may provide storage functionality, the communications circuitry 178 may provide network interface functionality, and the like.

In some embodiments, the processor 172 (and/or co-processor or any other processing circuitry assisting or otherwise associated with the processor) may be in communication with the memory 174 via a bus for passing information among components of, for example, the control circuit 112. The memory 174 may be non-transitory and may include, for example, one or more volatile and/or non-volatile memories, or some combination thereof. In other words, for example, the memory 174 may be an electronic storage device (e.g., a non-transitory computer readable storage medium). The memory 174 may be configured to store information, data, content, applications, instructions, or the like, for enabling an apparatus, e.g., the control circuit 112, to carry out various functions in accordance with example embodiments of the present disclosure.

Although illustrated in FIG. 1F as a single memory, the memory 174 may comprise a plurality of memory components. The plurality of memory components may be embodied on a single computing device or distributed across a plurality of computing devices. In various embodiments, the memory 174 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 174 may be configured to store information, data, applications, instructions, or the like for enabling the control circuit 112 to carry out various functions in accordance with example embodiments discussed herein. For example, in at least some embodiments, the memory 174 may be configured to buffer data for processing by the processor 172. Additionally, or alternatively, in at least some embodiments, the memory 174 may be configured to store program instructions for execution by the processor 172. The memory 174 may store information in the form of static and/or dynamic information. This stored information may be stored and/or used by the control circuit 112 during the course of performing its functionalities.

The processor 172 may be embodied in a number of different ways and may, for example, include one or more processing devices configured to perform independently. Additionally, or alternatively, the processor 172 may include one or more processors configured in tandem via a bus to enable independent execution of instructions, pipelining, and/or multithreading. The processor 172 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 1F as a single processor, in some embodiments, the processor 172 may include a plurality of processors. The plurality of processors may be embodied on a single computing device or may be distributed across a plurality of such devices collectively configured to function as the control circuit 112. The plurality of processors may be in operative communication with each other and may be collectively configured to perform one or more functionalities of the control circuit 112 as described herein.

In an example embodiment, the processor 172 may be configured to execute instructions stored in the memory 174 or otherwise accessible to the processor 172. Alternatively, or additionally, the processor 172 may be configured to execute hard-coded functionality. As such, whether configured by hardware or software methods, or by a combination thereof, the processor 172 may represent an entity (e.g., physically embodied in circuitry) capable of performing operations according to an embodiment of the present disclosure while configured accordingly. Alternatively, as another example, when the processor 172 is embodied as an executor of software instructions, the instructions may specifically configure the processor 172 to perform one or more algorithms and/or operations described herein when the instructions are executed. For example, these instructions, when executed by the processor 172, may cause the control circuit 112 to perform one or more of the functionalities thereof as described herein.

In some embodiments, the control circuit 112 may further include input/output circuitry 176 that may, in turn, be in communication with the processor 172 to provide an audible, visual, mechanical, or other output and/or, in some embodiments, to receive an indication of an input (e.g., ELS unit operational data, including usage statistics, diagnostic data, telemetry data, device logs, and/or the like) from a user or another source. In that sense, the input/output circuitry 176 may include means for performing analog-to-digital and/or digital-to-analog data conversions. The input/output circuitry 176 may include support, for example, for a display, touchscreen, keyboard, mouse, image capturing device (e.g., a camera), microphone, and/or other input/output mechanisms. The input/output circuitry 176 may include a user interface and may include a web user interface, a mobile application, a kiosk, or the like.

The processor 172 and/or user interface circuitry comprising the processor 172 may be configured to control one or more functions of a display or one or more user interface elements through computer-program instructions (e.g., software and/or firmware) stored on a memory accessible to the processor 172 (e.g., the memory 174, and/or the like). In some embodiments, aspects of input/output circuitry 176 may be reduced as compared to embodiments where the control circuit 112 may be implemented as an end-user machine or other type of device designed for complex user interactions. In some embodiments (like other components discussed herein), the input/output circuitry 176 may be eliminated from the control circuit 112. The input/output circuitry 176 may be in communication with memory 174, communications circuitry 178, and/or any other component(s), such as via a bus. Although more than one input/output circuitry and/or other component can be included in the control circuit 112, only one is shown in FIG. 1F to avoid overcomplicating the disclosure (e.g., as with the other components discussed herein).

The communications circuitry 178, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 178 may include, for example, a network interface for enabling communications with a wired or wireless communication network. For example, in some embodiments, communications circuitry 178 may be configured to receive and/or transmit any data that may be stored by the memory 174 using any protocol that may be used for communications between computing devices. For example, the communications circuitry 178 may include one or more communication ports, network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 178 may include circuitry for interacting with the antenna(s) to cause transmission of signals via the antenna (e) or to handle receipt of signals received via the antenna (e). These signals may be transmitted by the control circuit 112 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 178 may additionally or alternatively be in communication with the memory 174, the input/output circuitry 176, and/or any other component of the control circuit 112, such as via a bus. The communication circuitry 178 of the control circuit 112 may also be configured to receive and transmit information to and from the various components associated therewith.

The operational redundancy circuitry 180, may, in some embodiments, ensure the reliability and continuous performance of ELS units (e.g., the plurality of ELS units 102 as shown in FIG. 1). Accordingly, the operational redundancy circuitry 180 may be configured to monitor the operational status of each ELS unit, detecting instances where an operational failure has already occurred. For instance, the operational redundancy circuitry 180 may monitor the photodiodes integrated in the ELS units using periodic sampling techniques to identify a laser failure. The operation status data of the ELS units may be continuously monitored such that the RELS unit may be triggered for immediate usage should an ELS unit fail.

Upon identifying such conditions, the operational redundancy circuitry 180 may initiate a series of actions to mitigate any disruption in service. Specifically, the operational redundancy circuitry 180 may, (i) activate the RELS unit (e.g., RELS unit 104 as shown in FIG. 1A), (ii) configure operational parameters of the RELS unit to match the operational parameters of the compromised ELS, (iii) deactivate the compromised ELS unit, and (iv) transmit control signals to an optical switch (e.g., the optical switch 106 as shown in FIG. 1A) associated with the compromised ELS unit to trigger a reconfiguration of the system to substitute the operational capability of the compromised ELS unit with the operational capability of the RELS unit using an optical coupler (e.g., optical couplers 108 as shown in FIG. 1) corresponding to the compromised ELS.

The machine learning circuitry 182 may be configured to improve the proactive maintenance and operational stability of the optical communication system by detecting potential failures in ELS units before they occur. Unlike traditional approaches that respond to failures only after they have disrupted system performance, the machine learning circuitry 182 may continuously monitor the operational characteristics of each ELS unit, including optical, electrical, physical, and thermal parameters. By analyzing the operational characteristics in real-time, the machine learning circuitry 182 may use a trained machine learning model to identify patterns and anomalies that indicate a high likelihood of imminent operational failure. The machine learning model deployed by the machine learning circuitry 182 may be trained on historical data, including known performance characteristics and operational statuses of ELS units. Such training may allow the machine learning model to recognize early warning signs that may precede a failure, enabling the system to anticipate and mitigate issues before they escalate. Upon detecting that an ELS unit is likely to fail, the machine learning circuitry 182 may trigger an alert within the control system, initiating a preemptive response (e.g., using the operational redundancy circuitry 180) to maintain the system's operational integrity.

In some embodiments, the control circuit 112 may include hardware, software, firmware, and/or a combination of such components, configured to support various aspects of providing ELS resiliency as described herein. It should be appreciated that in some embodiments, the operational redundancy circuitry 180 and/or the machine learning circuitry 182 may perform one or more of such example actions in combination with another circuitry of the control circuit 112, such as the memory 174, processor 172, input/output circuitry 176, and/or communications circuitry 178. For example, in some embodiments, the operational redundancy circuitry 180 and/or the machine learning circuitry 182 may utilize the processing circuitry, such as the processor 172 and/or the like, to form a self-contained subsystem to perform one or more of its corresponding operations. In a further example, and in some embodiments, some or all of the functionality of the operational redundancy circuitry 180 and/or the machine learning circuitry 182 may be performed by the processor 172. In this regard, some or all of the example processes and algorithms discussed herein can be performed by at least one processor 172, the operational redundancy circuitry 180 and/or the machine learning circuitry 182. It should also be appreciated that, in some embodiments, the operational redundancy circuitry 180 and/or the machine learning circuitry 182 may include a separate processor, specially configured FPGA, or ASIC to perform its corresponding functions.

Additionally, or alternatively, in some embodiments, the operational redundancy circuitry 180 and/or the machine learning circuitry 182 may use the memory 174 to store collected information. For example, in the control circuit 112, in some implementations, the operational redundancy circuitry 180 and/or the machine learning circuitry 182 may include hardware, software, firmware, and/or a combination thereof, that interacts with the memory 174 to store data related to the operational status and historical performance of each ELS unit. The data may include a range of data types, including, but not limited to, operational parameters, error logs, performance metrics, predictive indicators of potential failures, and/or the like. Such stored information can be valuable for diagnostic purposes, enabling timely identification of trends that may indicate the likelihood of future failures. Furthermore, this data repository can serve as a foundation for implementing predictive maintenance strategies, optimizing the operational efficiency of the system, and facilitating recovery actions in the event of ELS unit failures, thereby enhancing overall system reliability and reducing downtime.

Accordingly, non-transitory computer readable storage media, which may, for example, be the memory 174, can be configured to store firmware, one or more application programs, and/or other software, which include instructions and/or other computer-readable program code portions that can be executed to direct operation of the control circuit 112 to implement various operations, including the examples described herein. As such, a series of computer-readable program code portions may be embodied in one or more computer-program products and can be used, with a device, control circuit 112, database, and/or other programmable apparatus, to produce the machine-implemented processes discussed herein. It is also noted that all or some of the information discussed herein can be based on data that is received, generated and/or maintained by one or more components of the control circuit 112. In some embodiments, one or more external systems (such as a remote cloud computing and/or data storage system) may also be leveraged to provide at least some of the functionality discussed herein.

It should be recognized that the structure of the control circuit 112, as detailed herein, represents merely one embodiment among a multitude of potential configurations. This particular structure of the control circuit 112, as described herein, demonstrates a specific arrangement and interaction of its components-encompassing data processing units, network interfaces, and operational redundancy circuitry-that collectively contribute to its comprehensive system capabilities. However, this outlined configuration is not definitive or limiting. The structure of the control circuit 112 and its integral components can be varied to adapt to different networking paradigms, technological evolutions, and specific application needs. Thus, while the present disclosure depicts one potential structure for the control circuit 112, it is to be understood that this represents just one exemplification within the broader realm of network-enabled devices. The scope of the disclosure is, therefore, not confined to this singular form but is extendable to various other forms, technologies, and configurations.

### Example Machine Learning Architecture

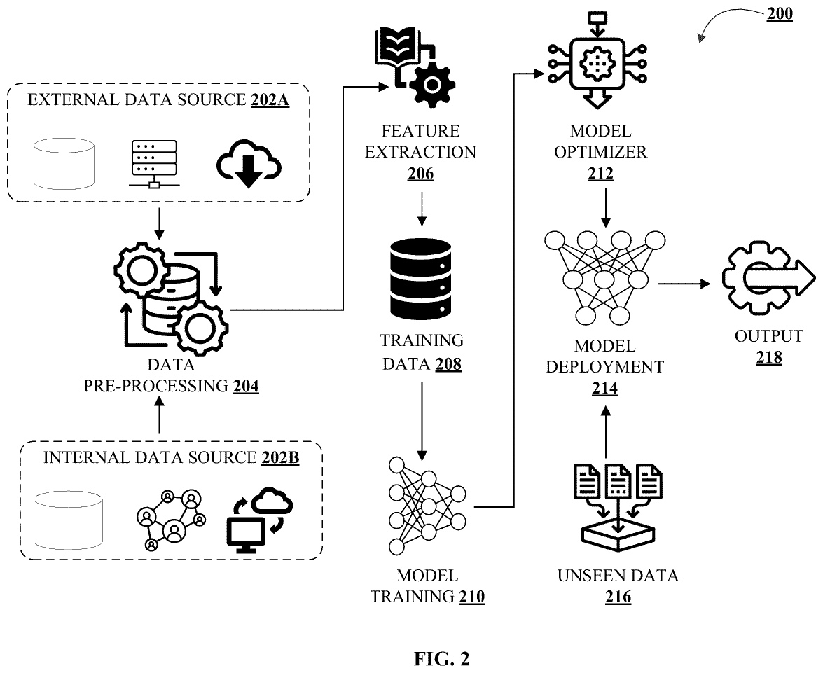

FIG. 2 illustrates an exemplary machine learning architecture 200 in accordance with an embodiment of the disclosure. The machine learning architecture 500 may include various external 202A and internal data sources 202B to generate, test, and integrate new features for training the machine learning model. The data sources (e.g., external data sources 202A and internal data sources 202B) can be initial locations where data originates or where physical information is first digitized. The data may be transported from each data source using applicable network protocols, such as the File Transfer Protocol (FTP), Hyper-Text Transfer Protocol (HTTP), or various Application Programming Interfaces (APIs) provided by websites, networked applications, and other services.

The data sources may include logs from network traffic within routers, switches, and firewalls that capture data related to traffic patterns, access control, and data flow. In high-performance computing (HPC) systems, data may be sourced from storage arrays, computational model outputs, and simulation data repositories. For optical communication systems, data sources may include monitoring devices and systems such as transceivers, multiplexers, and demultiplexers that track signal strength, bandwidth utilization, and error rates. Additional sources include datacenters containing information from servers, storage devices, and virtualization platforms; IoT and edge devices such as sensors, actuators, and smart devices collecting and transmitting data on environmental conditions, operational metrics, and user interactions; telecommunications systems providing call detail records, network usage statistics, and performance data; network management systems (NMS) generating metrics and logs regarding network health, performance, and configuration; and cybersecurity systems providing alerts, logs, and event data from intrusion detection systems (IDS), intrusion prevention systems (IPS), and security information and event management (SIEM) systems.

The data obtained from these sources may have various structures and formats. To facilitate effective analysis, the data may be pre-processed. Data pre-processing 204 may involve several steps, including cleaning, transformation, and advanced integration and processing. Cleaning the data may involve standardizing formats, filling in missing values, smoothing out noise, resolving inconsistencies, and removing outliers. Transformation processes may include aggregating, normalizing, and encoding data into suitable structures for analysis. Advanced integration and processing steps may be implemented to prepare the data for machine learning execution. As such, advanced integration and processing steps may involve changing the value, structure, or format of the data through generalization, normalization, attribute selection, and aggregation.

Once pre-processed, the data may undergo feature extraction 206. Feature extraction and selection techniques may be implemented to generate training data 208 by reducing the dimensionality of the initial data set, making it more manageable for processing. Large data sets often contain a significant number of variables, requiring substantial computing resources. Feature extraction 206 may involve selecting and combining variables into features, thereby reducing the volume of data to be processed while maintaining an accurate and comprehensive representation of the original data set. Depending on the machine learning algorithm employed, the training data 208 may need further enrichment. For supervised learning, the training data 208 may be enhanced with meaningful labels that provide context, allowing the machine learning model to learn from it. Labels may indicate the presence of specific objects in images, transcribed words in audio recordings, or medical conditions in x-rays. Data labeling may be used in applications such as computer vision, natural language processing, and speech recognition. Recent advancements also see the integration of automated data labeling tools that leverage artificial intelligence to label data at scale, improving efficiency. In contrast, unsupervised learning utilizes unlabeled data to identify patterns, such as inferences or clusters, within the data set. Emerging techniques in unsupervised learning, like self-supervised learning and contrastive learning, are increasingly being adopted to improve the ability of models to understand and organize data without manual labeling.

The resulting training data 208 may be used to train the machine learning model 210. Training a machine learning model involves using a training framework to process the training data 208, enabling the model to make predictions or decisions without explicit programming. The trained model encapsulates the knowledge acquired by the selected machine learning algorithm, which includes rules, numerical parameters, and algorithm-specific data structures required for tasks such as classification. Selecting the appropriate machine learning algorithm may depend on various factors, such as the problem statement, desired output, data type and size, available computational resources, and the number of features and observations in the data. Machine learning algorithms, which consist of mathematical and logical programs, are designed to self-adjust and improve as they are exposed to more data. These machine learning algorithms can modify their parameters based on feedback from previous performance in predicting outcomes on a dataset. Training frameworks such as TensorFlow, Boost, Caffe, Microsoft Cognitive Toolkit/CNTK, MXNet, Chainer, Keras, Deeplearning2j, and others facilitate this training process by providing the necessary tools and libraries to build, train, and optimize machine learning models.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C2.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

In the context of deep neural networks, training may involve using the frameworks to handle complex, multi-layered neural networks. The process typically includes data preparation, where pre-processed training data is fed into the neural network, which may be labeled or unlabeled depending on the type of learning. During forward propagation, input data may pass through the network's layers, with each layer performing calculations and transformations based on its parameters. The network's output may then be compared to the expected output using a loss function to calculate the error. In backpropagation, this error may be propagated back through the network, and the training framework adjusts the network's weights and biases to minimize the error. Optimization algorithms, such as stochastic gradient descent, Adam, or RMSprop, may be used to update the model's parameters iteratively. Such an iterative process of forward propagation, loss calculation, backpropagation, and optimization may continue for many epochs until the model's performance reaches a satisfactory level.

In supervised learning, the training data 208 may include inputs paired with desired outputs. The training framework may process these inputs and compare the resulting outputs against expected outputs, propagating errors back through the model and adjusting the weights iteratively to improve accuracy until the model achieves the desired performance. For example, in training a neural network, this involves forward propagation of inputs through the network layers, calculation of the loss based on the difference between actual and expected outputs, and backpropagation to update the network weights. In unsupervised learning, the training data 208 may include unlabeled data, and the machine learning model may attempt to find patterns or groupings within this data using techniques such as self-organizing maps, clustering algorithms, or dimensionality reduction methods like autoencoders. These methods enable the model to identify underlying structures in the data without predefined labels. Semi-supervised learning may combine both labeled and unlabeled data, leveraging the labeled data to guide the learning process while also extracting patterns from the unlabeled data. Semi-supervised learning may be particularly useful when labeled data is scarce or expensive to obtain. For instance, a neural network can be trained with a mix of labeled and unlabeled images, using the labeled data to establish initial learning parameters and the unlabeled data to refine and expand the model's understanding. Incremental learning, including techniques such as transfer learning, may allow a trained machine learning model to adapt to new data without forgetting previously learned knowledge, which is especially useful for applications where the model needs to continuously learn from new data. For example, a neural network can leverage transfer learning to apply knowledge gained from one task to improve performance on a related task. Furthermore, techniques such as self-supervised learning, where the model generates its own labels from the data, and contrastive learning, which improves the model's ability to understand the relationships between data points, have enhanced the efficiency and effectiveness of training machine learning models. These methods enable models to learn from large amounts of unlabeled data and improve their generalization capabilities. By utilizing these training frameworks and techniques, machine learning models, particularly deep neural networks, can be trained to achieve high accuracy and robust performance across a wide range of applications.

Once trained, the machine learning model may be optimized using a model optimizer 212. The model optimizer 212 may streamline the transition from the training environment to deployment by performing various optimization tasks, such as resizing inputs, modifying batch sizes, quantizing weights, and/or the like to enhance the model's performance and efficiency. By generating an internal representation of the model, the model optimizer 212 may adjust its structure to reduce computational overhead, ensuring effective operation across different hardware platforms, such as GPUs, CPUs, and FPGAs. Such optimization may improve the model's scalability and execution speed, making it more suitable for practical use.

Once the machine learning model is trained and optimized, it can be deployed 214 into a production environment for practical use. Deployment 214 may involve integrating the trained model into an application or system where it can process live data and make real-time predictions or decisions. The deployment 214 process may include several steps such as exporting the model from the training framework, converting it into a format suitable for the target environment, and optimizing it for performance and scalability. The trained machine learning model can be deployed 214 on various platforms, including cloud services, edge devices, or on-premises infrastructure. During deployment 214, the trained machine learning model may be monitored and maintained to track its performance, manage updates, and address any issues that arise.

Unseen data 216, referred to as test data or live data, is new information that the trained machine learning model has not encountered during its training phase. The unseen data 216 data may be introduced to evaluate the trained machine learning model's ability to generalize and make accurate predictions on previously unknown inputs. Unseen data 216 may originate from various sources similar to those used during training (e.g., external data sources 202A and internal data sources 202B), such as logs, sensor readings, or user-generated content, but it has not been included in the dataset used to train the model. The introduction of unseen data 216 may be used to assess the model's real-world performance and its capacity to handle a diverse range of inputs beyond the training data 208.

When unseen data 216 is fed into the trained model, the model processes this data to generate an output 218. This output 218 may take various forms depending on the nature of the machine learning task. For instance, in a classification task, the output 218 may be a label or category prediction, such as identifying an object in an image or detecting sentiment in a text. In regression tasks, the output 218 may be a continuous value, such as predicting house prices based on market data. For models used in natural language processing or computer vision, the output 218 may include sequences of text, transcriptions, or detailed image annotation.

Once the model generates an output 218, the output 218 may be transmitted to a user device or integrated into a larger system for practical application. The output 218 may be formatted and packaged into a suitable data structure, such as JSON or XML, which can be interpreted by the receiving system. This packaged output may then be transmitted over a network using protocols such as HTTP or through application programming interfaces (APIs). The receiving user device, which may be a smartphone, tablet, or desktop computer, may process the received data to present it to the user. Such processing may involve rendering visual predictions on a screen, generating alerts or notifications, or integrating the output into a user-facing application interface.

The machine learning architecture described herein may support heterogeneous execution, which refers to the ability to run different portions of a program on different types of processors and cores, leveraging the strengths of various hardware components, such as running compute-intensive tasks on GPUs while utilizing CPUs for sequential processing. Such an approach may maximize the efficiency and speed of machine learning applications (e.g., deep neural network applications), making it ideal for complex and resource-demanding tasks.

It will be understood that the embodiment of the machine learning architecture illustrated in Figure is exemplary and that other embodiments may vary. For instance, in some embodiments, the machine learning architecture may include additional, fewer, or different components. Variations in the configuration of the components and the implementation of the processes described herein are anticipated and within the scope of this disclosure. Modifications may include, but are not limited to, the integration of alternative data sources, different optimization techniques, or the incorporation of advanced algorithms and methodologies. The scope of the disclosure is not limited to the specific configurations and components described herein, and various modifications and adaptations may be made by those skilled in the art without departing from the spirit and scope of the disclosure. This disclosure encompasses any such variations, adjustments, or enhancements that maintain the core functionality and purpose of the machine learning architecture.

The ML architecture described herein can be employed in a wide range of applications, including but not limited to genomics, cognitive computing, and various machine learning tasks. These tasks may involve training or inferencing software, as well as machine learning frameworks such as PyTorch, TensorFlow, Caffe, and other relevant software used in conjunction with one or more embodiments.

### Example Method for Providing Operational Resilience for a Failed ELS Unit

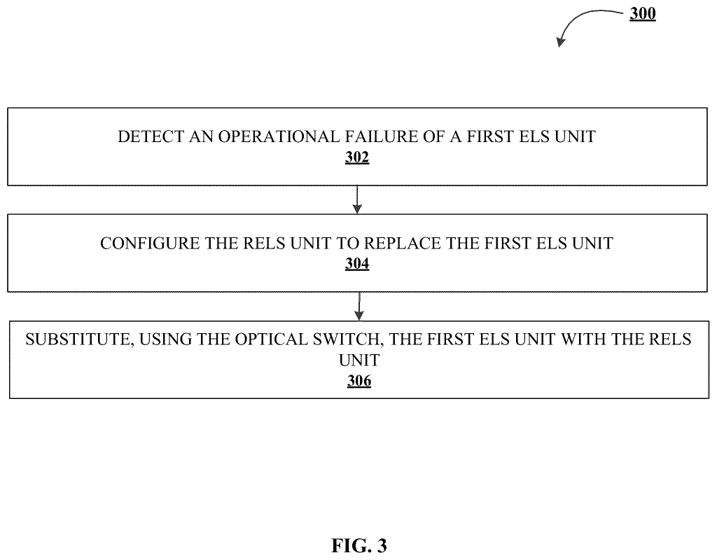

FIG. 3 illustrates an example method 300 for providing operational resilience for a failed ELS unit, in accordance with an embodiment of the disclosure. As shown in block 302, an operational failure of an ELS unit is detected. As described herein, control circuit may be configured to monitor the operational status of each ELS, scanning for signs that may indicate an impending failure or detecting instances where an operational failure has already occurred. In this regard, the control circuit may be configured to monitor functional characteristics of each ELS. The functional characteristics may include optical characteristics, electrical characteristics, physical/thermal characteristics, and/or the like. The optical characteristics may include output power, wavelength stability, beam quality, spectral purity, and/or the like; the electrical characteristics may include threshold current, operating current, voltage, and/or the like; physical/thermal characteristics may include temperature, cooling efficiency, mechanical stability, and/or the like.

In an example embodiment, the control circuit may be configured to monitor the functional characteristics of each ELS unit and detect that an ELS unit has failed based on deviations or anomalies in performance indicators from their expected values or operational thresholds. For example, a significant drop or complete absence of output power (as measured by the control unit), not attributable to normal operational controls, could indicate a failure, a sudden increase in threshold current or unusual fluctuations in operating voltage, can signal failure of the ELS unit, deviations beyond specified limits of emitted wavelength and spectral purity an indicate failure, overheating or abnormal temperature variations can signal failure, and/or the like.

As shown in block 304, the RELS unit is configured to replace the first ELS unit. Upon detecting the operational failure of the first ELS unit, the RELS unit may be configured for replacement. In this regard, the operational parameters of the RELS unit may be configured to match the operational parameters of the first ELS unit. The operational parameters may include optical path alignment, wavelength selection, thermal stabilization, control software engagement, safety protocols, feedback loop establishment, and/or the like.

In some instances, the RELS unit may be in an inactive state while the ELS units are functional and operational. As such, as part of configuring the REL unit, the RELS unit may be activated prior to being configured to replace the first ELS unit. Activating the RELS unit may include initiating the power supply to the unit, thereby bringing all internal systems online. Initiating the power supply may involve restoring electrical power to the control electronics, cooling systems, and other support circuits within the RELS unit to ensure that it is fully operational. The activation process may also include initializing the RELS unit's embedded systems, which may involve booting up the control software, running self-diagnostic checks, and establishing communication with the control circuit. During this phase, the RELS unit's environmental conditions, such as temperature and humidity, may be stabilized to meet operational specifications, ensuring that the unit is in optimal condition before the laser components are engaged. In example embodiments, in addition to activating the RELS, the optical paths from the output of the RELS unit may be rerouted, using the optical switch and optical couplers, to combine the output of the RELS unit with that of the first ELS unit for continued operation, without interruption or degradation of performance.

In some example embodiments, however, the RELS unit may already be active. For example, the RELS unit may already be operating as a replacement to a previously failed ELS unit. In such cases, the RELS unit may be reconfigured to prioritize replacement of the first ELS unit over the previously failed ELS unit. Alternatively, the previously failed ELS unit may have been replaced, and the RELS unit may be deactivated as the replacement of the previously failed ELS unit. However, the operational parameters of the RELS unit may still be configured for the previously failed ELS unit. In such cases, operational parameters of the RELS unit may be reconfigured to match the operational parameters of the first ELS unit for replacement.

As shown in block 306, the first ELS is substituted with the RELS unit using an optical switch, thereby replacing an operational capability of the first ELS with an operational capability of the RELS unit. In an example embodiment, prior to substituting the first ELS unit with the RELS unit, the first ELS may be deactivated. Deactivating the first ELS may include a sequence of steps to safely terminate operation, to minimize potential damage to the system. As such, deactivating the first ELS unit may include disabling electrical supply to the first ELS unit and the lasers housed therewithin, engaging emergency shutdown protocols, implementing optical isolation measures, deactivating software, physical disconnection, and/or the like.

To replace the first ELS unit with the RELS unit, the control circuit may transmit control signals to an optical switch (e.g., optical switch 106 as described in FIG. 1A) to trigger replacement. The optical switch, in response to receiving the control signals, may modify the routing of the optical path. In this regard, the optical switch may employ optical couplers (e.g., optical couplers 108 as described in FIG. 1A) to disengage the first ELS unit from the optical circuit and engage the RELS unit (often simultaneously). Disengaging the first ELS unit from the optical circuit may refer to disconnecting the first ELS unit from the optical path to prevent its degraded or failed signals from transmitting. Engaging the RELS unit may refer to rerouting the optical signals through the RELS unit, effectively substituting it into the optical path to maintain uninterrupted signal transmission.

Once the RELS unit is engaged via the optical switch, the control circuit may initiate the activation of the lasers housed within the RELS unit to restore the operational capability of the system. The activation process may involve a series of coordinated steps to ensure that the transition from the first ELS unit to the RELS unit is seamless and that the RELS unit operates within the required performance parameters. In an example embodiment, the activation of the RELS unit's lasers may begin with the control circuit restoring electrical supply to the RELS unit, ensuring that all internal components receive the necessary power to function correctly. The control circuit may then initiate a warm-up sequence for the lasers, allowing them to reach optimal operating conditions, such as the correct temperature and power levels, to avoid any fluctuations or instability in the optical output. Following the warm-up phase, the control circuit may perform a series of calibration procedures to align the laser outputs with the system's operational requirements. This calibration may include adjusting the wavelength, power output, and modulation settings to match the specific needs of the optical circuit. Once calibrated, the lasers in the RELS unit are fully activated and integrated into the optical communication path. During and after the activation process, the control circuit may continue to monitor the performance of the RELS unit, ensuring that the lasers are operating within the expected parameters and that the transition has not introduced any errors or signal degradation. If necessary, the control circuit may make further adjustments to fine-tune the RELS unit's performance, ensuring that the system maintains its intended functionality without interruption.

### Example Method for Providing Operational Resilience for a Failing ELS Unit

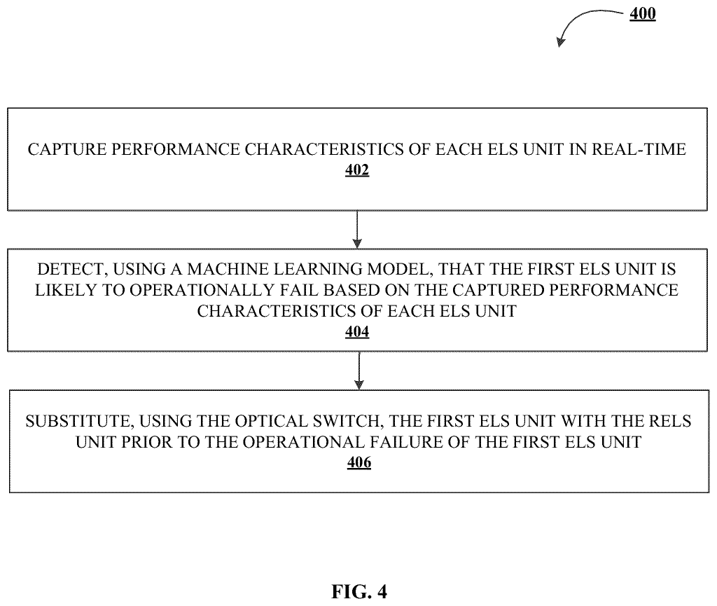

FIG. 4 illustrates an example method 400 for providing operational resilience for a failing ELS unit, in accordance with an embodiment of the disclosure. As shown in block 402, the performance characteristics of each ELS unit is captured in real-time. These performance characteristics may include optical, electrical, physical, and thermal parameters, which provide a comprehensive view of the operational status of each ELS unit. The real-time monitoring of these characteristics allows the system to continuously assess the condition of each ELS unit during its operation. The data collected from these parameters may serve as the input for further analysis and decision-making processes within the system, ensuring that the system can respond promptly to any deviations from normal operating conditions.

As shown in block 404, a machine learning model may be used to detect that the first ELS unit is likely to operationally fail based on the captured performance characteristics of each ELS unit. The machine learning circuitry, as depicted in FIG. 1F, may analyze the real-time data collected from each ELS unit, comparing it against patterns and thresholds established during the training phase of the machine learning model. The training of the machine learning model may involve the use of historical data, including known performance characteristics and the operational statuses of ELS units, allowing the model to identify early indicators of potential failures. By applying this model to the real-time data, the system may detect anomalies or trends that suggest an impending failure, thereby enabling proactive maintenance and reducing the risk of unscheduled downtime.

As shown in block 406, the first ELS unit is substituted with the RELS unit using the optical switch prior to the operational failure of the first ELS unit. The substitution of the first ELS unit with the REL unit may occur before the operational failure of the first ELS unit, thereby ensuring continuity in the optical communication system. In particular embodiments, the control circuit may deactivate the first ELS unit as part of this process, including steps such as disabling the electrical supply and engaging any necessary shutdown protocols. The optical switch may then modify the routing of the optical path, disengaging the first ELS unit and engaging the RELS unit in its place, ensuring that the operational capability of the system is maintained without interruption, allowing for continued performance and reliability.

### Example Implementation for Providing Operational Resilience

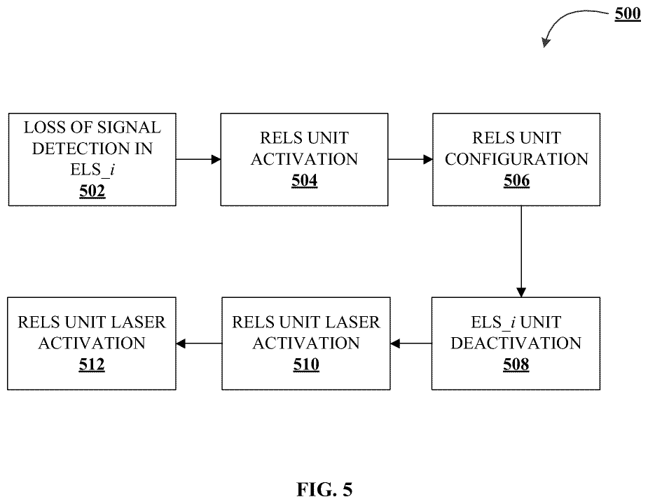

FIG. 5 illustrates an example implementation for providing operational resilience, in accordance with an embodiment of the disclosure. As depicted in block 502, the process may begin with the detection of a loss of signal in the ELS unit identified as ELS_i. The detection may trigger the control circuitry to initiate a sequence of operations designed to maintain system functionality and avoid service disruption. Following the detection of the signal loss, as shown in block 504, the RELS unit may be activated. In specific embodiments, during normal operation of the system (e.g., CPO system), the lasers in the RELS unit may be maintained in the OFF state, while the control circuit (e.g., control circuit 112) is ON and communicating with switch host.

Activating the RELS unit may involve powering up the unit, initializing its control systems, preparing it for integration into the optical network, and/or the like. The activation of the RELS unit is done in preparation for replacing the malfunctioning ELS_i unit.

Once the RELS unit is activated, the process may proceed to block 506, where the RELS unit is configured to match the operational parameters of the ELS_i unit. Configuring the RELS unit may involve adjusting the wavelength, power levels, and other relevant parameters to ensure that the RELS unit can seamlessly take over the operational role of the failed ELS unit without disrupting the system's performance. Concurrently, or immediately after, as depicted in block 508, the ELS_i unit may be deactivated. Deactivating the ELS_i unit may include disconnecting the electrical supply, disengaging it from the optical circuit, performing any necessary shutdown procedures to safely remove the unit from active operation, and/or the like, to prevent any further impact on the system from the failed unit.

Subsequently, as shown in block 510, the lasers within the RELS unit may be activated. The activation of the lasers may include powering up the lasers, performing calibration to align the output with system requirements, and ensuring that the lasers are functioning correctly before they are fully integrated into the optical path. Finally, as indicated in block 512, the RELS unit laser activation process may be completed, and the RELS unit fully takes over the operational capabilities of the ELS_i unit. At this stage, the optical communication system may continue functioning as intended, with the RELS unit seamlessly replacing the failed ELS_i unit.

Maintenance operations may be conducted at a time deemed convenient, during which the failed ELS_i is replaced with a new ELS unit. The newly installed ELS unit may then be powered ON, configured with updated operational parameters to match, or improve upon its predecessor's (e.g., ELS_i) performance. Following the successful integration and testing of the new ELS unit, the RELS unit may be deactivated, signifying their return to standby mode. Finally, the optical switch may be used to re-engage the new ELS unit into the system's operational framework within a very short time to allow for seamless replacement, completing the maintenance cycle and restoring the system to its optimal configuration.

Initiating the RELS unit by plan may eliminate the typical 5 ms switching time that occurs when the system responds reactively to an ELS unit failure. In this planned approach, the switching may be performed before the ELS unit is fully swapped out, allowing the system to transition to the RELS unit. As a result, the total time between the detection of a loss of signal and the substitution of the RELS unit may be less than 50 ms. This rapid response time allows for maintaining the stability of the system. Moreover, the substitution of the RELS unit may happen automatically when an ELS unit fails, further improving the system's reliability by reducing the need for manual intervention.

The inclusion of a RELS unit in the system may result in a minor increase in power consumption. During normal operation, the power increase may be less than 0.1 pJ/b when compared to a system without a RELS unit. For a 2×1 switch configuration, there may be an additional power increase of approximately 0.07 pJ/b due to an optical loss increase of 0.2 dB. In a 2×1 combiner configuration, the power increase may be more significant, approximately 1.5 pJ/b, corresponding to an optical loss increase of 3 dB. During the operation of the RELS unit, while the faulty ELS unit is being replaced, there may be a temporary power increase of approximately 0.6 pJ/b, with the total optical path loss remaining under 1.5 dB. The estimated cost increase for integrating a RELS unit is approximately 10% over a standard optical device (e.g., CPO switch box) without an RELS unit. Despite these changes, the overall system size may remain effectively unchanged, as the added RELS cage and switches can fit within the existing CPO switch form factor.

As such, the introduction of a RELS unit may address reliability concerns in large CPO systems by offering fast and automatic optical switching of a faulty ELS unit by a RELS unit, with a recovery time of less than 50 ms. Such capability allows for the replacement of the faulty ELS unit at a more convenient time, supporting planned maintenance with minimal system downtime. The system achieves this with a reasonable increase in power consumption (less than 0.1 pJ/b) and system cost (less than 10%).

In an alternate embodiment, instead of or in addition to relying on an external RELS unit to provide redundancy, the system may be configured for operational resilience using an internal ELS unit redundancy mechanism. In this regard, each ELS unit may include a redundant laser housed therewithin. When a particular laser in an ELS unit is compromised, the redundant laser may be activated to replace the compromised laser to maintain operational resilience. To implement such a redundancy, each ELS unit may include internal optical switching components such as optical switches, optical couplers, and potentially other components necessary for seamless switching and integration of the redundant laser into the operational pathway. The foregoing description of the specific embodiments for providing operational resilience using an internal ELS unit redundancy mechanism reveals the general nature of the disclosure sufficiently to enable persons skilled in the art to readily adapt and apply its principles in various forms, each embodying the disclosure but possibly differing in detail from the manifestation herein described.

It is to be understood that variations and modifications of the described processes may be implemented without departing from the scope of the disclosure, as defined by the claims. The steps and sequence depicted in the flowchart are merely one example of how operational resilience may be achieved, and other implementations may differ based on specific system requirements and configurations.

### Example Datacenter

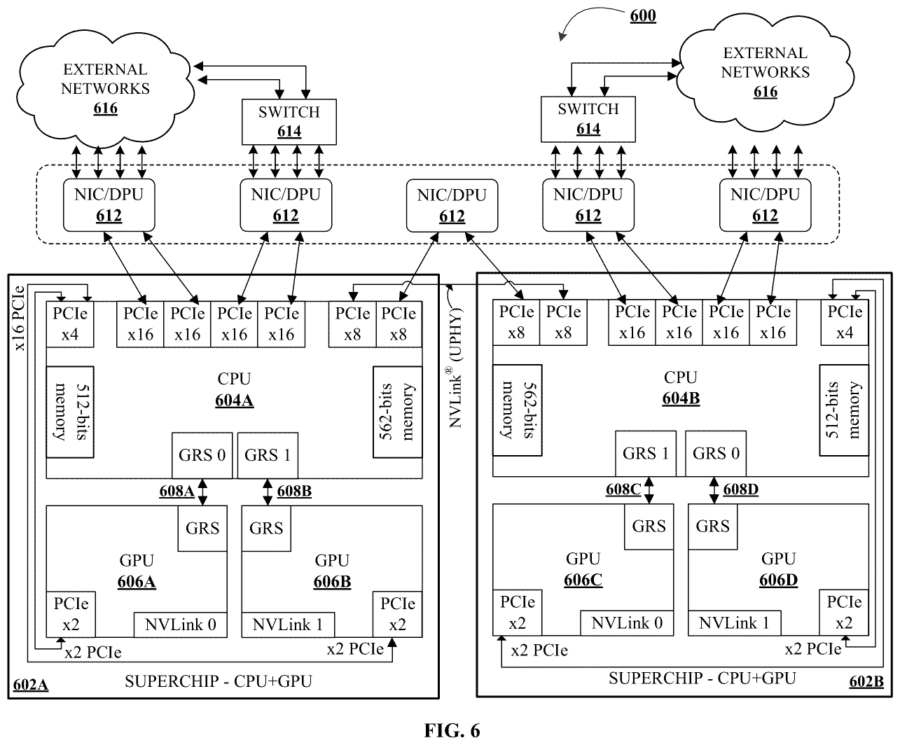

FIG. 6 illustrates a schematic diagram of an example datacenter 600, in accordance with an embodiment of the disclosure. The datacenter 600 may include high-performance computing (HPC) clusters 602A, 602B, network interface controller/data processing units (NIC/DPUs) 608, switches 614, and external networks 616. The HPC clusters 602A, 602B may house computing resources. The NIC/DPUs 612 may act as intermediate processing and management units that facilitate data transmission between HPC clusters 602A, 602B and datacenter switches 614. The datacenter switches 614 may manage and route data between the HPC clusters 602A, 602B and the external networks 616. The external networks 616 may connect the datacenter 600 to external devices, services, or other datacenters, enabling communication beyond the datacenter.

HPC clusters (e.g., HPC clusters 602A, 602B) may house various computing resources designed to support computationally demanding tasks. These HPC clusters may include central processing units (CPUs), such as NVIDIA Grace™ CPUs, and graphics processing units (GPUs), such as NVIDIA® H600 Tensor Core GPUs, memory modules, and interconnects to facilitate data exchange and processing. In example embodiments, each HPC cluster may be configured to handle specific types of workloads, such as general-purpose computing, data processing, specialized tasks like artificial intelligence (AI) and machine learning (ML) applications, and/or the like. For example, NVIDIA® Tensor Core GPUs may be used to accelerate AI and ML workloads by performing parallel processing of large datasets. The configuration of the HPC clusters may be scalable, allowing for additional compute nodes, such as those with GPUs and CPUs, to be added or removed as needed based on computing requirements.

In specific embodiments, the CPU and/or the GPUs, or portions or components thereof, may be embodied as or include a chip or chipset. In other words, the CPU and/or the GPUs may include physical packages (e.g., chips) including materials, components, and/or wires on a structural assembly (e.g., a baseboard). The structural assembly may provide physical strength, conservation of size, and/or limitation of electrical interaction for component circuitry included thereon. The CPU and/or the GPUs, may therefore, in some cases, be configured to implement an embodiment of the disclosure on a single chip or as a single “system on a chip (SoC).” As such, in some cases, a chip or chipset may constitute means for performing one or more operations for providing the functionalities described herein. In this configuration, the CPU may be coupled to a GPU via die-to-die (D2D) interconnects, chip-to-chip (C2C) interconnects, such as a Ground-Referenced Signaling (GRS) interconnect, and/or the like, allowing for low-latency communication and high bandwidth between the CPU and GPU. Additionally, the CPU can connect to multiple GPUs using both D2D/C2C interconnects and high-speed interconnects, such as PCIe interconnects, such as PCIe Gen 5×61 lanes. Within each HPC cluster, the GPUs may also be operatively coupled to one another to facilitate direct GPU-to-GPU communication using high-speed interconnect technologies such as NVLink® or other interconnects specifically designed for direct GPU communication. NVLink® may provide a high-bandwidth, low-latency communication channel between GPUs, supporting data synchronization and sharing for tasks that require significant inter-GPU communication, such as matrix computations, simulations, or AI model training.

In the embodiment shown in FIG. 6, CPU 604A is operatively coupled to GPUs 606A and 606B via GRS-compatible interconnects, 608A and 608B, and CPU 604B is operatively coupled to GPUs 604C and 606D via GRS-compatible interconnects, 608C and 608D. Each CPU may include GRS-compatible ports, such as GRS 0 and GRS 6, which are configured to interface with corresponding GRS ports on the GPUs. For example, CPU 604A may utilize its GRS 0 port to connect to GPU 606A and its GRS 6 port to connect to GPU 606B, while CPU 604B may use its GRS 0 and GRS 6 ports to connect to GPUs 604C and 606D, respectively. The GRS-compatible interconnects may provide pathways for data exchange, workload distribution, and processing synchronization between the CPUs and GPUs, supporting high-bandwidth, low-latency communication. Alternatively or additionally, the CPUs 604A and 604B may be operatively coupled to GPUs 606A, 6046, 606C, and 606D via PCIe interconnects. These PCIe interconnects may utilize multi-lane configurations, such as PCIe Gen 4 or Gen 5×61 lanes, to provide high-bandwidth, scalable data transfer channels between the CPUs and GPUs. In this configuration, the PCIe interconnects may support dynamic link width adjustments, allowing the bandwidth to scale based on workload intensity, thereby optimizing resource allocation within the system.

GPUs 606A and 606B within HPC cluster 602A and GPUs 604C and 606D within HPC cluster 602B may be interconnected via NVLink® interconnects via NVLink® compatible ports, NVLink 0 and NVLink 6 respectively, allowing coordinated parallel processing across GPUs for computationally demanding workloads. HPC clusters 602A and 602B may be interconnected through high-bandwidth interconnect, such as an NVLink® or Unified Physical Layer (UPHY) interconnect, allowing for data transfer and synchronization between the server systems. The high-bandwidth interconnect may support parallel processing and may improve the overall computational throughput of the HPC cluster, making it suitable for applications like artificial intelligence (AI), machine learning (ML), and data-intensive simulations. Each CPU (e.g., 604A) within a HPC cluster (e.g., 602A) may be equipped with memory modules, such as a 562-bit memory module, to provide data access for both CPUs and GPUs. The memory modules may be directly connected to the respective CPUs, reducing latency and supporting high-speed operations.

As shown in FIG. 6, the HPC clusters 602A and 602B may be operatively coupled to NIC/DPUs 612, enabling efficient offloading of data processing and security tasks, further reducing the computational burden on the server CPUs and improving overall data flow within the rack. Each NIC/DPU 612 may integrate NIC and DPU functionalities to enhance the efficiency of datacenter operations. The NIC/DPU 612 may be configured to offload various network, storage, and security tasks from the HPC clusters (e.g., HPC cluster 602A, 602B), in particular, CPUs in the HPC clusters, allowing the CPUs to focus on compute-intensive workloads. The NIC/DPU 612 may facilitate high-speed data transmission, optimize data flow, and enable advanced network services with minimal impact on server performance. The NIC component within the NIC/DPU 612 may handle standard network functions, such as packet transmission and reception, supporting high-speed Ethernet or InfiniBand® protocols. By facilitating fast data transfers between the HPC clusters 602A and 602B and external networks 616, the NIC enables efficient communication across the datacenter environment. The NIC may also support offloading network protocol processing, reducing the overhead on HPC clusters 602A and 602B, in particular, CPUs in the HPC clusters 602A and 602B, and improving overall data throughput. The DPU component of the NIC/DPU 612 may extend these capabilities by offloading more advanced processing tasks, such as data encryption and decryption, packet inspection and filtering, virtualization support, and/or the like. In example embodiments, DPU may be NVIDIA BlueField®-2 DPUs, which provide a high-performance platform for datacenter acceleration. The BlueField-2 architecture may include up to 8 Arm cores, enabling the NIC/DPU 612 to execute network, storage, and security tasks independently of the HPC clusters, in particular, CPUs in the HPC clusters. By performing these tasks closer to the data source, the NIC/DPU 612 may reduce data movement across the network, lower latency, and enhance overall system efficiency.

The NIC/DPU 612 may also include a dedicated memory subsystem, such as dynamic random-access memory (DRAM), to support local processing and ensure high-speed data access. Additionally, the NIC/DPU 612 may be configured to manage NVMe over Fabrics (NVMe-oF) storage protocols, allowing for efficient remote storage access and fast data retrieval. The combined NIC and DPU functionalities within the NIC/DPU 612 may support various advanced networking features, including traffic shaping and load balancing, remote direct memory access (RDMA), virtual machine and container isolation, and/or the like.

Switches 614 may manage the data flow between the HPC clusters 602A, 602B and the external networks 616. The switches 614 may be responsible for routing and distributing data between servers within the datacenter and facilitating communication with external networks. Switches 614 may be configured to support various high-speed network protocols, such as Ethernet or InfiniBand® protocols, depending on the performance and bandwidth requirements of the datacenter. The switches 614 may include optical switches, which use light signals for data transmission, offering high bandwidth and low latency for long-distance communication. Alternatively, the switches 614 may include electrical switches, which rely on electronic signals and may be used for shorter distances or when lower latency is a priority. In some configurations, hybrid switches may be used, combining both optical and electrical components to balance performance and flexibility. The switches 614 may be advanced networking switches, such as Nvidia Quantum-2 switches, configured to provide high throughput capabilities. The switches 614 may operate at different layers of the network stack, including Layer 2 (data link layer) and Layer 3 (network layer), to perform switching and routing functions. Multiple switches 614 may be interconnected to provide redundancy and load balancing for reliable data transfer even if one switch fails. The switches 614 may support scalable configurations, allowing the network architecture to expand as additional HPC clusters 602A, 602B or external networks 616 are introduced.

In certain embodiments, the number and arrangement of switches 614 within the datacenter 600 may be based on the overall network topology deployed in the datacenter environment. The choice of network topology may influence the scalability, performance, fault tolerance, and bandwidth distribution of the network, thus affecting how many switches are required and how they are interconnected. Examples of network topology may include fat-tree topology, SlimFly topology, dragonfly topology, HyperX topology, torus topology, Clos (folded-Clos) topology, mesh topology and/or the like. For instance, in a fat-tree topology, the network is structured as a multi-tiered hierarchy with equal-cost paths between any two endpoints. The fat-tree topology may be built using three layers of switches: leaf switches at the bottom layer, directly connected to the HPC clusters 602A, 602B, spine switches in the middle layer, which interconnect the leaf switches, and core switches at the top, which interconnect multiple sets of spine switches, as described in further detail in FIG. 2. In a SlimFly topology, the switches 614 may be arranged to minimize the average path length between servers, reducing communication latency. The total number of switches 614 may be fewer than in fat-tree topology, but their arrangement may be more complex to optimize the number of direct and indirect connections between nodes. Dragonfly topology may organize switches into groups (or “pods”), with high-bandwidth connections within each group and lower-bandwidth connections between groups. The switches 614 may be arranged into several pods, with each pod containing a set of leaf switches connected to HPC clusters 602A, 602B and local spine switches. In addition, there may be fewer inter-pod connections than intra-pod connections. In hyperX topology, switches may be arranged in a multi-dimensional grid, with each switch connected to multiple neighboring switches in different dimensions. The total number of switches may scale with the number of dimensions and network size. In a torus topology, the switches 614 may be connected in a loop or ring structure. Torus topology may offer reduced wiring complexity and built-in redundancy, as each switch is connected to multiple adjacent switches. In larger datacenters, a higher-dimensional torus (e.g., 3F or 4D torus) may be implemented, where switches are arranged in a multi-layered grid. In a Clos topology, also known as a folded-Clos or CLOS architecture, the switches 614 may be arranged in multiple layers of switching stages, with each stage containing multiple switches. In this configuration, each server system 602 may connect to a set of leaf switches, which in turn connect to multiple spine switches. Additional spine and leaf switches may be added as the network grows, with the number of switches 614 increasing in proportion to the number of server systems and external networks connected.

The external networks 616 represent a range of connectivity options that facilitate communication between the datacenter and various external systems, such as other datacenters, cloud service providers, and/or the like. These external networks 616 may include local area networks (LANs), which connect devices within a limited geographical area, as well as WANs that span larger distances and connect multiple LANs. Additionally, external networks 616 may include cloud networks, which provide scalable resources and services hosted remotely, and private networks, which offer secure communication channels for sensitive data transfer. Other types of external networks may include virtual private networks (VPNs) that enable secure access over the internet and Content Delivery Networks (CDNs) that optimize the delivery of content to end-users. Each of these external networks may utilize various communication protocols, such as Ethernet, InfiniBand®, or MPLS (Multiprotocol Label Switching) protocols, to ensure reliable and efficient data transfer.

It should be noted that the description provided herein is merely one embodiment of the datacenter 600 and the associated components, including the switches 614 and the NIC/DPU 612. Various modifications, alterations, and adaptations may be made without departing from the scope of the disclosure. The specific configurations, components, and functionalities described are illustrative and may be replaced or modified in other embodiments depending on the particular requirements of the datacenter environment. For example, different network topologies, alternative processing units, or variations in server configurations may be used to achieve similar objectives. As such, the scope of the disclosure should not be limited by the described embodiment.

### Example Fat Tree Topology

FIG. 7 illustrates an example fat tree topology 700 for a datacenter, in accordance with embodiments of the disclosure. It should be understood that the present disclosure is not limited to the use of a fat-tree topology. Alternative network topologies and configurations are contemplated within the scope of this disclosure, including any modifications, variations, or adaptations that align with the principles and objectives described herein.

As shown in FIG. 7, the fat tree topology may include three distinct layers: the edge layer 702, the aggregation layer 704, and the core layer 706. The edge layer 702, located at the bottom of the hierarchy, incorporates Top-of-Rack (ToR) switches. The edge layer 702 may serve as the initial point of aggregation for traffic originating from the servers (e.g., HPC clusters 602A, 602B), not illustrated in the figure. The edge layer 702 may include a plurality of switches (e.g., switches 114), designated as ELS1, ELS2, . . . , ELSn, as shown in FIG. 7. The aggregation layer 704 may be positioned above the edge layer 702 and may further consolidate traffic from multiple edge layer switches ELS₁, ELS₂, . . . , ELSₙ. The aggregation layer 704 may be composed of switches (e.g., switches 114) ALS₁, ALS₂, . . . , ALSₒ. The aggregation layer switches may be configured to aggregate data traffic from the edge layer 702, ensuring efficient load balancing and data flow management. At the top of the hierarchy is the core layer 706, which may provide high-speed interconnectivity and enables communication among different racks within the datacenter 600. The core layer 706 may include a series of switches (e.g., switches 614) labeled as CLS₁, CLS₂, . . . , CLSₘ. These core layer switches may be configured to ensure that data can traverse the network quickly and efficiently, minimizing latency and maximizing bandwidth.

The switches within each layer (e.g., edge layer 702, aggregation layer 704, core layer 706) may be 1 U switches, where “1 U” refers to the industry-standard size for rack-mounted switches and servers. As described herein, the switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch. An optical switch, on the other hand, may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections 710 between the switches within the network topology may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

One such technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

Another technology is Frequency Division Multiplexing (FDM). In FDM, multiple optical signals can be transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

Yet another technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber. Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A network switch system, comprising:
a plurality of external laser source (ELS) units;
a redundant external laser source (RELS) unit;
an optical switch operatively coupled to the RELS unit; and
a control circuit operatively coupled to the plurality of ELS units, the RELS unit, and the optical switch, wherein the control circuit is configured to:
detect an operational failure of a first ELS unit; and
in response to detecting the operational failure of the first ELS unit:
configure the RELS unit to replace the first ELS unit; and
substitute, using the optical switch, the first ELS unit with the RELS unit.

2. The network switch system of claim 1, wherein, in substituting the first ELS unit with the RELS unit, the control circuit is further configured to:
disengage, using an optical coupler associated with the first ELS unit, the first ELS unit; and
engage the RELS unit in place of the first ELS unit.

3. The network switch system of claim 1, wherein the optical coupler comprises passive optical couplers, wherein the passive optical couplers comprise optical combiners.

4. The network switch system of claim 1, wherein the optical coupler comprises active optical couplers, wherein the active optical couplers comprise optical switches.

5. The network switch system of claim 1, wherein the control circuit is further configured to:
deactivate the first ELS unit prior to substituting the first ELS unit with the RELS unit.

6. The network switch system of claim 1, wherein a transition time associated with the substitution of the first ELS unit with the RELS unit is in a range of approximately 1-10 milliseconds.

7. The network switch system of claim 1, wherein the control circuit is configured to continuously monitor an operational status of each ELS unit.

8. The network switch system of claim 1, wherein the control circuit is further configured to:
capture performance characteristics of each ELS unit in real-time;
detect, using a machine learning model, that the first ELS unit is likely to operationally fail based on the captured performance characteristics of each ELS unit; and
substitute, using the optical switch, the first ELS unit with the RELS unit prior to the operational failure of the first ELS unit.

9. The network switch system of claim 8, wherein the performance characteristics comprise at least one of optical characteristics, electrical characteristics, physical characteristics, or thermal characteristics.

10. The network switch system of claim 8, wherein the control circuit is further configured to:
train the machine learning model using known performance characteristics and known operational status associated with each ELS unit,
wherein detecting that the first ELS unit is likely to operationally fail comprises using the trained machine learning model.

11. The network switch system of claim 1, wherein the RELS unit is maintained in an off state or stand-by state when the plurality of ELS units is operational.

12. The network switch system of claim 1, wherein, in configuring the RELS unit to replace the first ELS unit, the control circuit is further configured to:
configure parameters of the RELS unit to match parameters of the first ELS unit prior to substituting the first ELS unit with the RELS unit.

13. The network switch system of claim 1, wherein the control circuit is further configured to:
determine an addition of a new ELS unit to replace the first ELS unit;
configure parameters of the new ELS unit; and
substitute the RELS unit with the new ELS unit, thereby replacing the first ELS unit.

14. The network switch system of claim 13, wherein the control circuit is further configured to:
deactivate the RELS unit in response to substituting the RELS unit with the new ELS unit.

15. The network switch system of claim 1, wherein the system is a co-packaged optical (CPO) system.

16. A method comprising:
detecting an operational failure of a first external laser source (ELS) unit in a plurality of ELS units; and
in response to detecting the operational failure of the first ELS unit:
configuring a redundant external laser source (RELS) unit to replace the first ELS unit; and
substituting, using an optical switch, the first ELS unit with the RELS unit.

17. The method of claim 16, wherein substituting the first ELS unit with the RELS unit further comprises:
disengaging, using an optical coupler associated with the first ELS unit, the first ELS unit; and
engaging the RELS unit in place of the first ELS unit.

18. A computer program product comprising a non-transitory computer-readable medium comprising code that, when executed by a processor, causes the processor to:
detect an operational failure of a first external laser source (ELS) unit in a plurality of ELS units; and
in response to detecting the operational failure of the first ELS unit:
configure a redundant external laser source (RELS) unit to replace the first ELS unit; and
substitute, using an optical switch, the first ELS unit with the RELS unit.

19. The computer program product of claim 18, wherein the code, when executed to substitute the first ELS unit with the RELS unit, further causes the processor to:
disengage, using an optical coupler associated with the first ELS unit, the first ELS unit; and
engage the RELS unit in place of the first ELS unit.

20. A network switch system, comprising:
a plurality of external laser source (ELS) units;
a redundant external laser source (RELS) unit;
an optical device, wherein the optical device comprises a plurality of optical splitters, wherein the optical device is operatively coupled to the RELS unit; and
a control circuit operatively coupled to the plurality of ELS units, the RELS unit, and the optical device, wherein the control circuit is configured to:
detect an operational failure of a first ELS unit; and
in response to detecting the operational failure of the first ELS unit:
configure the RELS unit to replace the first ELS unit; and
substitute, using an optical splitter corresponding to the first ELS unit, the first ELS unit with the RELS unit.
